(19) United States
(12) Patent Application Publication
(10) Pub. No.: US 2017/0190139 A1
(43) Pub. Date: Jul. 6, 2017

(54) COATINGS AND COATED SURFACES WITH SELECTED SURFACE CHARACTERISTICS AND FEATURES

(71) Applicants: Atieh Haghdoost, San Pablo, CA (US); Mehdi Kargar, San Pablo, CA (US); Ali Najafi, Richmond, CA (US)

(72) Inventors: Atieh Haghdoost, San Pablo, CA (US); Mehdi Kargar, San Pablo, CA (US); Ali Najafi, Richmond, CA (US)

(21) Appl. No.: 15/392,330

(22) Filed: Dec. 28, 2016

Related U.S. Application Data
(60) Provisional application No. 62/273,405, filed on Dec. 30, 2015.
(60) Provisional application No. 62/299,480, filed on Feb. 24, 2016.
(60) Provisional application No. 62/358,513, filed on Jul. 5, 2016.

(51) Int. Cl. B32B 3/18; B32B 15/20; B32B 5/16; B32B 15/04

(52) U.S. Cl. CPC B32B 3/18; B32B 15/04; B32B 15/20; B32B 5/16

(57) ABSTRACT

Certain embodiments are described herein of coatings and articles comprising coatings. In some examples, the coating comprises a textured layer comprising at least one metal or metallic compound. The coating may also comprise a plurality of individual surface features in a micro- or nano-structure size range, wherein the plurality of surface features are positioned in different planes in different heights with respect to a reference zero point in the textured layer. In some instances, there is substantially no space between the plurality of surface features of the textured layer. Methods of producing the coatings are also described.

### PRIORITY CLAIM

This application claims priority to, and the benefit of, U.S. Provisional Application No. 62/273,405 filed on Dec. 30, 2015, and to U.S. Provisional Application No. 62/299,480 filed on Feb. 24, 2016, and to U.S. Provisional Application No. 62/358,513 filed on Jul. 5, 2016, the entire disclosure of each of which is hereby incorporated herein by reference for all purposes.

### STATEMENT REGARDING FEDERALLY SPONSORED RESEARCH

This invention was made with government support under Award Number 1519664 awarded by the National Science Foundation Small Business Innovation Research program. The government has certain rights in the invention.

### TECHNOLOGICAL FIELD

Certain configurations described herein are directed to coatings and surfaces which may comprise one or more coatings disposed thereon. In some examples, the coating can be configured with one or more textured layers which may comprise one or more features positioned within at least two different surface planes to provide hydrophobicity.

### BACKGROUND

Many articles are coated with one or more materials to impart some functional or aesthetic characteristics to the article. The coatings can be deposited in numerous ways.

### SUMMARY

In one aspect, an article comprising a substrate comprising a surface and a hydrophobic coating disposed on some portion of the surface is provided. In some examples, the coating comprises a textured layer comprising at least one metal or metallic compound and comprising a plurality of individual surface features in a micro- or nano-structure size range. For example, the plurality of surface features are or can be positioned in different planes in different heights with respect to a reference zero point in the textured layer. In some instances, there is substantially no space between the plurality of surface features of the textured layer.

In some examples, each of the plurality of surface features comprises smaller features to provide a hierarchical structure in the textured layer. In other examples, the metal of the textured layer is selected from the group consisting of nickel, copper, zinc, cobalt, chromium, manganese, silver, gold, titanium, cadmium, platinum, other transition metals and combinations thereof. In further examples, the metallic compound is selected from the group consisting of metal oxides, metal carbides, metal nitrides, metal hydroxides, metal carbonitrides, metal oxynitrides, metal borides, metal borocarbides, metal fluorides, other metal compounds, and combinations thereof. In some examples, the textured layer comprises a composite of metals or metallic compounds and nanoparticles. In certain embodiments, the nanoparticles are selected from the group consisting of PTFE particles, silica particles, alumina particles, silicon carbide, diatomaceous earth, boron nitride, titanium oxide, platinum oxide, diamond, particles formed from differential etching of spinodally decomposed glass, single wall carbon nanotubes, mix silicon/titanium oxide particles (TiO2/SiO2, titanium inner core/silicon outer surface), ceramic particles, thermo-chromic metal oxide, multi-wall carbon nanotubes, any chemically or physically modified versions of the foregoing particles, and any combination thereof. In other examples, the article comprises one or multiple conformal coating layers disposed on the textured layer and/or the hydrophobic coating. For example, the conformal coating layers comprises one or more of Chromium Nitride (CrN), Diamond Like Carbon (DLC), Titanium Nitride (TiN), Titanium Carbo-nitride (TiCN), Aluminum Titanium Nitride (ALTiN), Aluminum Titanium Chromium Nitride (AlTiCrN), Zirconium Nitride (ZrN), Nickel, gold, PlasmaPlus®, Cerablack™, Chromium, Nickel Fluoride (NiF2), any Nickel Composite, any organic or inorganic-organic material or combinations thereof. In some instances, the conformal coating layer comprises the nickel composite and the nickel composite is a composite of nickel with particles selected from the group consisting of PTFE, silica (SiO2), alumina (Al2O3), silicon carbide (SiC), diamond, diatomaceous earth (DE), boron nitride (BN), titanium oxide (TiO2), single wall carbon nanotubes (SWCNTs), multi-wall carbon nanotubes (MWCNTs), kaoline (Al2O3.2SiO2.2H2O), graphite, other nanoparticles, and any combinations thereof. In some embodiments, the conformal coating layer comprises the organic or inorganic-organic material and the organic or inorganic-organic material is selected from a group consisting of parylene, organofunctional silanes, fluorinated organofunctional silane, fluorinated organofunctional siloxane, organo-functional oligomeric siloxane, organofunctional resins, hybrid inorganic organofunctional resins, low-surface-energy resins, organofunctional polyhedral oligomeric silsesquioxane (POSS), hybrid inorganic organofunctional POSS resins, fluorinated oligomeric poly siloxane, organofunctional oligomeric poly siloxane, hybrid inorganic organofunctional oligomeric poly siloxane, fluorinated organofunctional silicone copolymers, organofunctional silicone polymers, hybrid inorganic organofunctional silicone polymers, organofunctional silicone copolymers, hybrid inorganic organofunctional silicone copolymers, fluorinated polyhedral oligomeric silsesquioxane (FPOSS), non-volatile linear and branched alkanes, alkenes and alkynes; esters of linear and branched alkanes, alkenes and alkynes, perfluorinated organic material, silane coupling agents Dynasylan® SIVO, other similar groups, or any combination thereof, parylene, organofunctional silanes, fluorinated alkylsilane, fluorinated alkylsiloxane, organofunctional resins, hybrid inorganic organofunctional resins, organofunctional polyhedral oligomeric silsesquioxane (POSS), hybrid inorganic organofunctional POSS resins, silicone polymers, fluorinated oligomeric polysiloxane, organofunctional oligomeric poly siloxane, fluorinated organofunctional silicone copolymers, organofunctional silicone polymers, hybrid inorganic organofunctional silicone polymers, organofunctional silicone copolymers, hybrid inorganic organofunctional silicone copolymers, fluorinated polyhedral oligomeric silsesquioxane (FPOSS), Dynasylan® SIVO, other similar groups, or any combination thereof. In some examples, the coating comprises a water contact angle of more than 90 degrees as tested by the ASTM D7490-13 standard, e.g., a water contact angle of at least 155 degrees or at least 160 degrees. In other examples, the coating has the pencil hardness level of more than 3B as tested by ASTM D3363-05(2011)e2 standard. In some embodiments, the coating meets at least level three of durability in the pull-off test (tape test) as tested by the ASTM F2452-04-2012 standard.

In other examples, the article comprises an additional layer disposed on the textured layer, wherein the additional layer comprises a lubricant, a polymer blend, nanoparticles, or any combination thereof such as polymer-nanoparticle composite materials is infused inside the surface features of the hydrophobic layer. In some instances, the additional layer comprises the nanoparticles and the nanoparticles are either treated with a low surface energy material in advance or a low surface energy material is added to the chemical blend of the additional layer. Examples of nanoparticles include but not limited to silica (SiO2), alumina (Al2O3), silicon carbide (SiC), diamond, diatomaceous earth (DE), boron nitride (BN), titanium oxide (TiO2), single wall carbon nanotubes (SWCNTs), multi-wall carbon nanotubes (MWCNTs), kaoline (Al2O3.2SiO2.2H2O), or any combination thereof. In other instances, the additional layer comprises the nanoparticles and wherein the nanoparticles comprise hydrophobic ceramic-based particles selected from a group consisting of hydrophobic fumed silica particles, hydrophobic diatomaceous earth (DE) particles, hydrophobic pyrogenic silica particles or any combination thereof. In further examples, the additional layer comprises a polymer blend and wherein the polymer blend comprises one or more of organic polymers, thermoplastic polymers, thermosetting polymers, copolymers, terpolymers, a block copolymer, an alternating block copolymer, a random polymer, homopolymer, a random copolymer, a random block copolymer, a graft copolymer, a star block copolymer, a dendrimer, a poly electrolyte, a polyampholyte (a polyelectrolyte having both cationic and anionic repeat groups), and an ionomer.

In some examples, the substrate is configured as a pipe and the hydrophobic coating comprises zinc. In other examples, the substrate is configured as a heating device and the hydrophobic coating comprises nickel. In further examples, the substrate is configured as a polymer mold and the hydrophobic coating comprises zinc

In another aspect, a method of producing a coating on a substrate comprises electrodepositing a metal or metallic compound on the substrate to provide a textured, hydrophobic coating comprising a textured layer comprising the metal or metallic compound and a plurality of individual surface features in a micro or nano-structure size range, wherein the plurality of individual surface features are positioned in different planes in different heights with respect to a reference zero point to provide a reference zero point in the textured layer, and wherein there is substantially no space between the plurality of surface features of the textured layer.

In some examples, the electrodepositing comprises providing an electrolyte mixture, placing the substrate as a part of a cathode in the electrolyte mixture, placing an anode in the electrolyte mixture, and electrodepositing the textured layer comprising the metal or metallic compound on the substrate, wherein the textured layer is rendered hydrophobic without any chemical treatment following the electrodepositing step. In some examples, the electrodepositing step is performed in an aqueous electrolyte mixture comprising at least one positively-charged agent that is reduced by applying a current and is used to provide the hydrophobic coating layer. For example, the method may comprise configuring the electrolyte mixture with at least one negatively-charged ion selected from the group consisting of bromide (Br—), carbonate (CO3-), hydrogen carbonate (HCO3-), chlorate (ClO3-), chromate (CrO4-), cyanide (CN—), dichromate (Cr2O72-), dihydrogenphosphate (H2PO4-), fluoride (F—), hydride (H—), hydrogen phosphate (HPO42-), hydrogen sulfate or bisulfate (HSO4-), hydroxide (OH—), iodide (I—), nitride (N3-), nitrate (NO3-), nitrite (NO2-), oxide (O2-), permanganate (MnO4-), peroxide (O22-), phosphate (PO43-), sulfide (S2-), thiocyanate (SCN—), sulfite (SO32-), sulfate (SO42-), chloride (Cl—), boride (B3-), borate (BO33-), disulfide (S22-), phosphanide (PH2-), phosphanediide (PH2-), superoxide (O2-), ozonide (O3-), triiodide (I3-), dichloride (Cl2-), dicarbide (C22-), azide (N3-), pentastannide (Sn52-), nonaplumbide (Pb94-), azanide or dihydridonitrate (NH2-), germanide (GeH3-), sulfanide (HS—), sulfanuide (H2S—), hypochlorite (ClO—), hexafluoridophosphate ([PF6]-), tetrachloridocuprate(II) ([CuCl4]2-), tetracarbonylferrate ([Fe(CO)4]2-), hydrogen(nonadecaoxidohexamolybdate) (HMo6O19-), tetrafluoroborate ([BF4-]), Bis(trifluoromethylsulfonyl)imide ([NTF2]-), trifluoromethanesulfonate ([TfO]-), Dicyanamide [N(CN)2]-, methylsulfate [MeSO4]-, dimethylphosphate [Me2PO4]-, acetate [MeCO2]-, and any combinations thereof. In other examples, the method may comprise configuring the electrolyte mixture with at least one additive selected from the group consisting of thiourea, acetone, ethanol, cadmium ion, chloride ion, stearic acid, ethylenediamine dihydrochloride, saccharin, cetyltrimethylammonium bromide (CTAB), sodium dodecyl sulfate, ethyl vanillin, ammonia, ethylene diamine, polyethylene glycol (PEG), bis(3-sulfopropyl)disulfide (SPS), Janus green B (JGB), azobenzene-based surfactant (AZTAB), the polyoxyethylene family of surface active agents, sodium citrate, perfluorinated alkylsulfate, additive K, calcium chloride, ammonium chloride, potassium chloride, boric acid, myristic acid, choline chloride, citric acid, any redox active surfactant, any conductive ionic liquids, wetting agents, leveling agents, defoaming agents, emulsifying agents and any combinations thereof.

In some examples, the method may comprise treating the substrate with the electrodeposited coating by annealing, thermal processing, vacuum conditioning, aging, plasma etching, grit blasting, wet etching, ion milling, exposure to electromagnetic radiation including visible light, UV, and X-rays, and combinations thereof. In other examples, the method may comprise coating an additional coating onto the substrate, by one or more of electrodeposition, electroless deposition, surface functionalization, electro-polymerization, spray coating, brush coating, dip coating, electrophoretic deposition, reaction with fluorine gas, plasma deposition, brush plating, chemical vapor deposition, sputtering, physical vapor deposition, passivation through the reaction of fluorine gas, or any combinations thereof. In some examples, the method may comprise electrodepositing the coating by varying a voltage that switches between an open circuit potential and a potential above gas formation of the electrolyte mixture during the electrodepositing step. In some instances, the method may comprise depositing a seed layer on the substrate prior to the electrodepositing step. In other examples, the method may comprise electrodepositing a second coating different from the electrodeposited coating subsequent to the electrodepositing step of the coating.

In an additional aspect, a hydrophobic coating comprises a textured layer comprising at least one metal or metallic compound and comprises a plurality of individual surface features in a micro- or nano-structure size range, wherein the plurality of surface features are positioned in different planes in different heights with respect to a reference zero point in the textured layer, and wherein there is substantially no space between the plurality of surface features of the textured layer.

In some embodiments, each of the plurality of surface features comprises smaller features to provide a hierarchical structure in the textured layer. In other embodiments, the coating comprises a water contact angle of more than 90 degrees as tested by the ASTM D7490-13 standard, e.g., a water contact angle of at least 155 degrees or at least 160 degrees. In other examples, the coating has a pencil hardness level of more than 3B as tested by ASTM D3363-05(2011)e2. In some examples, the coating meets at least level three of durability in the pull-off test (tape test) as tested by the ASTM F2452-04-2012 standard. In certain instances, the metal of the textured layer is selected from a group consisting of nickel, copper, zinc, cobalt, chromium, manganese, silver, gold, titanium, cadmium, platinum, other transition metals and combinations thereof. In other examples, the metallic compound is selected from a group consisting of metal oxides, metal carbides, metal nitrides, metal hydroxides, metal carbonitrides, metal oxynitrides, metal borides, metal borocarbides, metal fluorides, other metal compounds, and combination thereof. In further examples, the textured layer comprises a composite of metals or metallic compounds and nanoparticles.

In certain configurations, the metal comprises zinc and the water contact angle is at least 150 degrees as tested by the ASTM D7490-13 standard, e.g., at least 155 degrees or at least 160 degrees.

In other configurations, the metal comprises copper and the water contact angle is at least 150 degrees as tested by the ASTM D7490-13 standard, e.g., at least 155 degrees or at least 160 degrees.

In another aspect, a kit comprises an electrolyte mixture, an electrochemical cell comprising a cathode and an anode and configured to receive the electrolyte mixture, wherein the cathode is configured to receive or be part of a substrate, and instructions for using the electrolyte mixture and the electrochemical cell to electrodeposit a textured, hydrophobic coating on the substrate to provide a textured layer comprising the metal or metallic compound and a plurality of individual surface features in a micro or nano-structure size range, wherein the plurality of individual surface features are positioned in different planes in different heights with respect to a reference zero point to provide a texture of the texture of the textured, hydrophobic coating, and wherein there is substantially no space is present between the plurality of surface features of the textured layer to provide hydrophobicity to the electrodeposited, hydrophobic coating.

In some configurations, the electrolyte mixtures comprises a salt of nickel, copper, zinc, cobalt, chromium, manganese, silver, gold, titanium, cadmium, platinum, other transition metals and combinations thereof. In other instances, the metallic compound is selected from a group consisting of metal oxides, metal carbides, metal nitrides, metal hydroxides, metal carbonitrides, metal oxynitrides, metal borides, metal borocarbides, metal fluorides, other metal compounds, and combination thereof. In some embodiments, the electrolyte mixture comprises metals or metallic compounds to provide a composite of the metals or the metallic compounds in the coating. In certain examples, the electrolyte mixture comprises at least one negatively-charged ion when the electrolyte mixture is placed in water, the at least one negatively-charged ion selected from the group consisting of bromide (Br—), carbonate (CO3-), hydrogen carbonate (HCO3-), chlorate (ClO3-), chromate (CrO4-), cyanide (CN—), dichromate (Cr2O72-), dihydrogenphosphate (H2PO4-), fluoride (F—), hydride (H—), hydrogen phosphate (HPO42-), hydrogen sulfate or bisulfate (HSO4-), hydroxide (OH—), iodide (I—), nitride (N3-), nitrate (NO3-), nitrite (NO2-), oxide (O2-), permanganate (MnO4-), peroxide (O22-), phosphate (PO43-), sulfide (S2-), thiocyanate (SCN—), sulfite (SO32-), sulfate (SO42-), chloride (Cl—), boride (B3-), borate (BO33-), disulfide (S22-), phosphanide (PH2-), phosphanediide (PH2-), superoxide (O2-), ozonide (O3-), triiodide (I3-), dichloride (Cl2-), dicarbide (C22-), azide (N3-), pentastannide (Sn52-), nonaplumbide (Pb94-), azanide or dihydridonitrate (NH2-), germanide (GeH3-), sulfanide (HS—), sulfanuide (H2S—), hypochlorite (ClO—), hexafluoridophosphate ([PF6]-), tetrachloridocuprate(II) ([CuCl4]2-), tetracarbonylferrate ([Fe(CO)4]2-), hydrogen(nonadecaoxidohexamolybdate) (HMo6O19-), tetrafluoroborate ([BF4-]), Bis(trifluoromethylsulfonyl)imide ([NTF2]-), trifluoromethanesulfonate ([TfO]-), Dicyanamide [N(CN)2]-, methylsulfate [MeSO4]-, dimethylphosphate [Me2PO4]-, acetate [MeCO2]-, and any combinations thereof. In other examples, the electrolyte mixture comprises at least one additive selected from the group consisting of thiourea, acetone, ethanol, cadmium ion, chloride ion, stearic acid, ethylenediamine dihydrochloride, saccharin, cetyltrimethylammonium bromide (CTAB), sodium dodecyl sulfate, ethyl vanillin, ammonia, ethylene diamine, polyethylene glycol (PEG), bis(3-sulfopropyl)disulfide (SPS), Janus green B (JGB), azobenzene-based surfactant (AZTAB), the polyoxyethylene family of surface active agents, sodium citrate, perfluorinated alkylsulfate, additive K, calcium chloride, ammonium chloride, potassium chloride, boric acid, myristic acid, choline chloride, citric acid, any redox active surfactant, any conductive ionic liquids, wetting agents, leveling agents, defoaming agents, emulsifying agents and any combinations thereof.

In an additional aspect, a kit comprises an electrolyte mixture, and instructions for using the electrolyte mixture to electrodeposit a textured, hydrophobic coating on the substrate to provide a textured layer comprising the metal or metallic compound and a plurality of individual surface features in a micro or nano-structure size range, wherein the plurality of individual surface features are positioned in different planes in different heights with respect to a reference zero point to provide a texture of the texture of the textured, hydrophobic coating, and wherein there is substantially no space is present between the plurality of surface features of the textured layer to provide hydrophobicity to the electrodeposited, hydrophobic coating.

In certain examples, the electrolyte mixtures comprises a salt of nickel, copper, zinc, cobalt, chromium, manganese, silver, gold, titanium, cadmium, platinum, other transition metals and combinations thereof. In other examples, the metallic compound is selected from a group consisting of metal oxides, metal carbides, metal nitrides, metal hydroxides, metal carbonitrides, metal oxynitrides, metal borides, metal borocarbides, metal fluorides, other metal compounds, and combination thereof. In some embodiments, the electrolyte mixture comprises metals or metallic compounds to provide a composite of the metals or the metallic compounds in the coating. In some examples, the electrolyte mixture comprises at least one negatively-charged ion when the electrolyte mixture is placed in water, the at least one negatively-charged ion selected from the group consisting of bromide (Br—), carbonate (CO3-), hydrogen carbonate (HCO3-), chlorate (ClO3-), chromate (CrO4-), cyanide (CN—), dichromate (Cr2O72-), dihydrogenphosphate (H2PO4-), fluoride (F—), hydride (H—), hydrogen phosphate (HPO42-), hydrogen sulfate or bisulfate (HSO4-), hydroxide (OH—), iodide (I—), nitride (N3-), nitrate (NO3-), nitrite (NO2-), oxide (O2-), permanganate (MnO4-), peroxide (O22-), phosphate (PO43-), sulfide (S2-), thiocyanate (SCN—), sulfite (SO32-), sulfate (SO42-), chloride (Cl—), boride (B3-), borate (BO33-), disulfide (S22-), phosphanide (PH2-), phosphanediide (PH2-), superoxide (O2-), ozonide (O3-), triiodide (I3-), dichloride (Cl2-), dicarbide (C22-), azide (N3-), pentastannide (Sn52-), nonaplumbide (Pb94-), azanide or dihydridonitrate (NH2-), germanide (GeH3-), sulfanide (HS—), sulfanuide (H2S—), hypochlorite (ClO—), hexafluoridophosphate ([PF6]-), tetrachloridocuprate(II) ([CuCl4]2-), tetracarbonylferrate ([Fe(CO)4]2-), hydrogen(nonadecaoxidohexamolybdate) (HMo6O19-), tetrafluoroborate ([BF4-]), Bis(trifluoromethylsulfonyl)imide ([NTF2]-), trifluoromethanesulfonate ([TfO]-), Dicyanamide [N(CN)2]-, methylsulfate [MeSO4]-, dimethylphosphate [Me2PO4]-, acetate [MeCO2]-, and any combinations thereof. In other examples, the electrolyte mixture comprises at least one additive selected from the group consisting of thiourea, acetone, ethanol, cadmium ion, chloride ion, stearic acid, ethylenediamine dihydrochloride, saccharin, cetyltrimethylammonium bromide (CTAB), sodium dodecyl sulfate, ethyl vanillin, ammonia, ethylene diamine, polyethylene glycol (PEG), bis(3-sulfopropyl)disulfide (SPS), Janus green B (JGB), azobenzene-based surfactant (AZTAB), the polyoxyethylene family of surface active agents, sodium citrate, perfluorinated alkylsulfate, additive K, calcium chloride, ammonium chloride, potassium chloride, boric acid, myristic acid, choline chloride, citric acid, any redox active surfactant, any conductive ionic liquids, wetting agents, leveling agents, defoaming agents, emulsifying agents and any combination thereof.

Additional aspects, embodiments, configurations and examples are discussed in more detail herein.

### BRIEF DESCRIPTION OF THE FIGURES

Certain embodiments and configurations are described with reference to the figures in which:

FIG. 1a shows a low-magnification and FIG. 1b shows a high magnification of a textured layer illustrating certain surface features.

FIGS. 2a, 2b, 2c, 2d, 2e, 2f, 2g, 2h, 2i, 2j, 2k, 2l, 2m, 2n and 2o show examples of the textured layers claimed in the first embodiment (scale bar corresponds to 10 microns except micrograph shown in FIG. 2o).

FIGS. 3a, 3b and 3c are EDS results of some of the textured layers that are subject of this disclosure.

FIGS. 4a, 4b and 4c shows water droplet contact with FIG. 4a showing a non-textured coating, FIG. 4b showing a Teflon® coating, and FIG. 4c a textured coating layer that is subject of this disclosure and where textured and non-textured coatings are made of the same material.

FIGS. 5a and 5b are schematics of a water droplet brought into contact with FIG. 5a showing a textured surface and FIG. 5b showing a non-textured surface.

FIG. 6 shows steps of the electrodeposition technique.

FIG. 7 is an illustration of an electrodeposition apparatus.

FIG. 8a shows a recently-formed protrusion on the growing surface, and FIG. 8b shows growth of consecutive layers of smaller protrusions.

FIG. 9 shows the effect of additives on restricting a specific growth direction and forming the surface texture.

FIG. 10a is a schematic of substrate, FIG. 10b is a schematic of a textured layer, and FIG. 10c is a schematic of a conformal layer that that approximately follows the surface texture of its underneath layer.

FIGS. 11a and 11b show an image of a superhydrophobic zinc coating before (FIG. 11a) and after (FIG. 11b) a 8H pencil hardness test, FIGS. 11c-11d shows images of the NeverWet® coating before (FIG. 11c) and after (FIG. 11d) a 9B pencil hardness test, and FIG. 11e is a graph comparing the hardness of the superhydrophobic zinc coating with NeverWet® and Teflon® coatings.

FIGS. 12a-12d are images of our superhydrophobic coating before and after with FIGS. 12a (before) and 12b (after) showing images of 5H pencil hardness test and FIGS. 12c (before) and 12d (after) showing images of 9H pencil hardness test on two superhydrophobic coatings.

FIGS. 13a and 13b are photographs showing the results of the pull-off (tape) test on a superhydrophobic coating (FIG. 13a) and a NeverWet® coating (FIG. 13b).

FIGS. 14a-14b shows one of the superhydrophobic coatings before (FIG. 14a) and after (FIG. 14b) 5 cycles of Tabor abrasion test with 500 g loading weight at 60 rpm speed, and FIGS. 14c and 14d show a NeverWet® coating before (FIG. 14c) and after (FIG. 14d) 5 cycles of Tabor abrasion test with 500 g loading weight at 60 rpm speed.

FIGS. 15a-15b show a drop of cooking oil on one of the tested superhydrophobic coatings (FIG. 15a) and a Teflon® coating (FIG. 15b).

FIG. 16 is an illustration showing Left: Macroscopic object is in contact with almost the whole uncoated surface. Right: Macroscopic object is in contact with just a part of the coated surface and the other part of the coated surface is in contact with the media. As a result, compared to the uncoated surfaces (Left), transfer between the macroscopic object and the coated surface is discouraged.

FIG. 17 is an illustration showing Left: Micro/nano scale object is completely in contact with the uncoated surface. Right: Some part of the micro/nano scale object is in contact with the media not the coated surface. As a result, compared to uncoated surfaces (Left), the adhesion between micro/nano scale object and the textured surface may be weaker.

FIG. 18 is an illustration showing microscale and nanoscale objects may get entrapped between the topographical features.

FIG. 19 is an illustration showing reducing transfer of microscale and nanoscale objects, chemicals or/and reactive agents dissolved in fluid, etc. from the fluid to the surface due to super-repellency of the surface.

FIG. 20 is an illustration showing less tendency of objects in attaching to a coated surface with curved surface features (right) compared to a coated surface with flat surface features (left).

FIG. 21 is an illustration showing a vapor layer is formed between the features of the surface texture at high temperature.

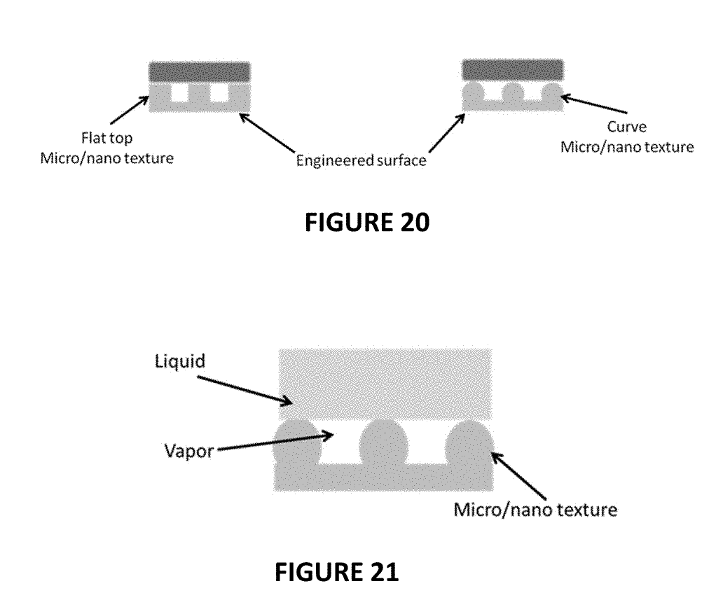

### DETAILED DESCRIPTION

Certain embodiments described herein are directed to coating comprising at least one textured layer. For example, the articles described herein may comprise one or more coatings which may comprise various features. In some instances, the coating may comprise at least one textured layer comprising a metal or metallic compound. In certain configurations, the textured layer provides a hydrophobic surface comprising a plurality of surface features in the micro or nano size range. The size of the surface features is defined based on their largest characteristic length. Some textured layers comprise surface features in the range of 5 to 15 micrometer. Others comprise surface features in the range of 0.5 to 1 micrometer. In some examples, the surface features are positioned within at least at two different surface planes with different heights in regard to an arbitrary zero reference point. In other instances, the features can be packed closely together with negligible, substantially no space or no space between adjacent features compared to the overall size of the features. In certain examples, the coating may comprise at least one textured layer with one or more of the following characteristics with respect to the arrangement of the surface features, composition, and hydrophobic characteristic of the textured layer.

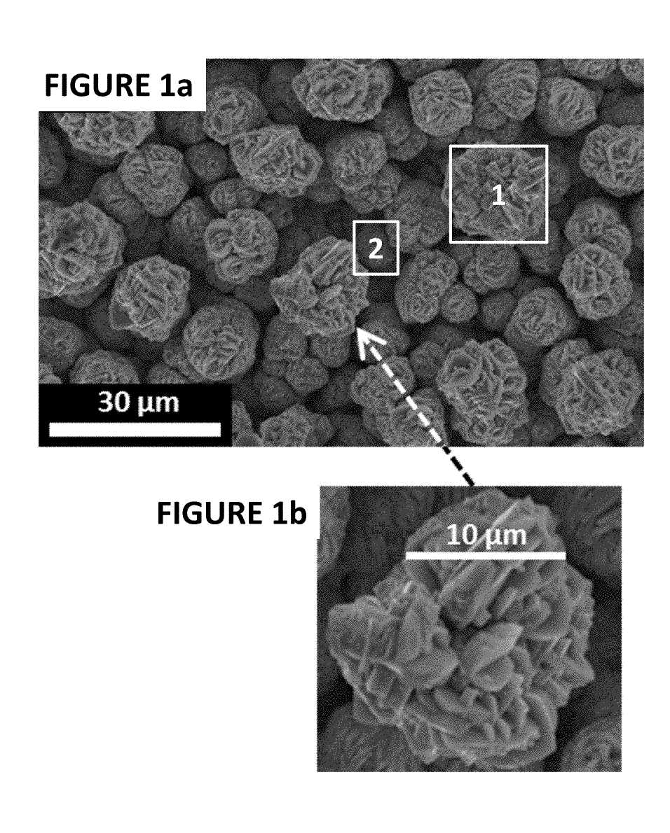

Referring to FIGS. 1a and 1b, electron micrographs are shown of textured layers illustrating some of the characteristics for the arrangement of certain surface features. The micrographs presented in this disclosure were obtained using an FEI Quanta Scanning Electron Micrograph of the textured layers comprising zinc. The textured layer comprises a plurality of surface features in the range of 5 to 15 micrometer. Two of these surface features are marked in FIG. 1a by reference numerals 1 and 2. The micro- or nano-size features are defined as features with at least one dimension in micro or nano size range, e.g., from several nanometers to several hundred micrometers. As discussed above, this size refers to the largest characteristic length of the surface features. As an instance, the surface features shown in FIG. 1a have approximate spherical shapes. The largest diameters of these spheres are defined as the size of the surface features. The surface features of the textured layer are desirably positioned at least at two different surface planes with different heights in regard to an arbitrary zero point. As an instance features 1 and 2 in FIG. 1a are positioned within two different surface planes, and therefore, feature 1 is closer to the viewer compared to feature 2. Moreover, as the electron micrograph in FIG. 1a shows each surface feature can be positioned adjacent to a plurality of other features at the same or different surface planes. While not wishing to be bound by this example, there is negligible space between adjacent features compared to the size of the features. Making elaborate surface textures such as that shown in FIGS. 1a-b using other micro- and nano-manufacturing techniques has not proven feasible or cost-effective. Using the materials and methods described herein, an affordable route for manufacturing intricate surface textures using existing manufacturing infrastructures in the industry can be implemented.

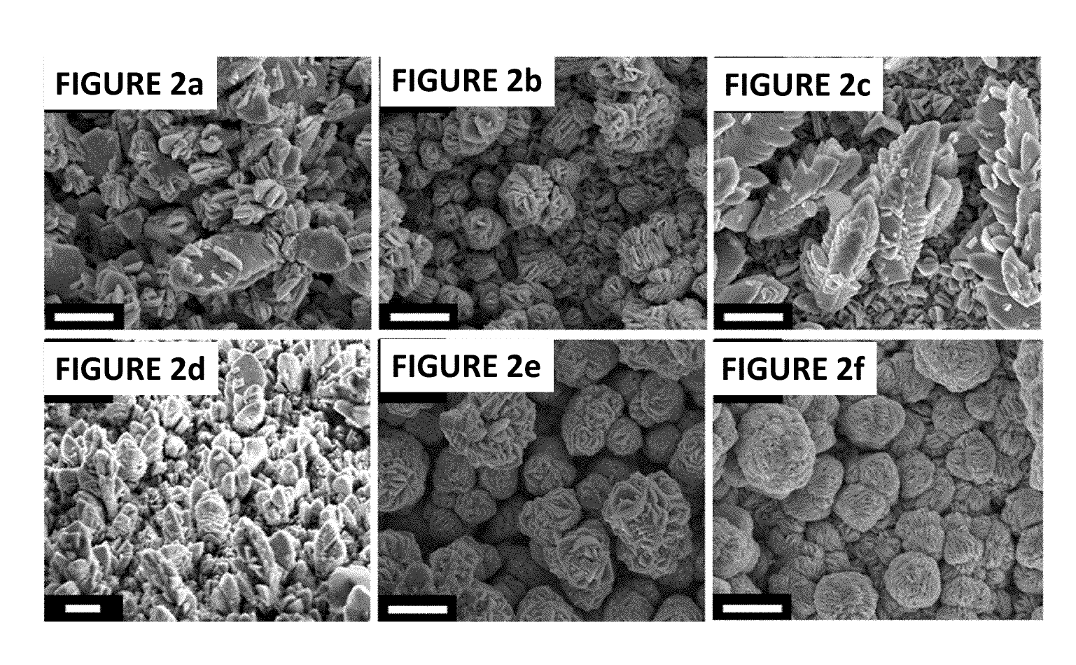

Referring now to FIGS. 2a-o, other examples of the textured layers are shown. These textured layers are made from different materials and different processes have been used for their manufacturing. However, all layers comprise a plurality of surface features in the micro or nano size range. Surface features of some of the textured layers shown in these figures resemble regular geometries. Mass of regular geometries is directly proportional to their characteristic dimension raised to an integer power (e.g. a third power for a sphere). As an instance, surface features shown in FIGS. 2b, 2e, 2f, 2i, 2l, 2h, 2g, 2j, 2n, and 2m all resemble spherical structures. However, the size of these spheres, the size distribution of the spherical features, and the small constituents comprising the spherical shapes are different for each surface texture shown in these figures. The bar graphs shown in these figures correspond to 10 microns. Some of these textured layers such as those shown in FIG. 2b comprise small spherical features with 5 micron diameter. In contrast, the size of the spherical features in some of the textured layers such as that shown in FIG. 2h goes all the way up to 15 microns. Unlike the aforementioned textured layers with regular surface features, some of the other textured layers, such as those shown in FIGS. 2a, 2c, 2d, 2k, and 2o, comprise surface features with irregular geometries. The mass of these irregular geometries is proportional to their characteristic dimension raised to a fractional power. The irregular surface features of different textured layers have different shapes and sizes. As an instance, the surface features shown in FIG. 2c have fractal structures while those shown in FIG. 2o have star-shaped structures. Among the textured layers shown in FIGS. 2a-o, the one presented in FIG. 2o has the smallest surface features. The scale bar in FIG. 2o corresponds to 2.5 microns unlike the scale bars in all other figures that represent 10 microns. Moreover, among the textured layers of FIGS. 2a-o, only the one shown in FIG. 2n comprises faceted surface features. The surface features of this textured layer comprise smooth planes each facing to a specific direction. The other textured layers all comprise non-faceted surface features and the constituents of their surface features do not represent specific direction.

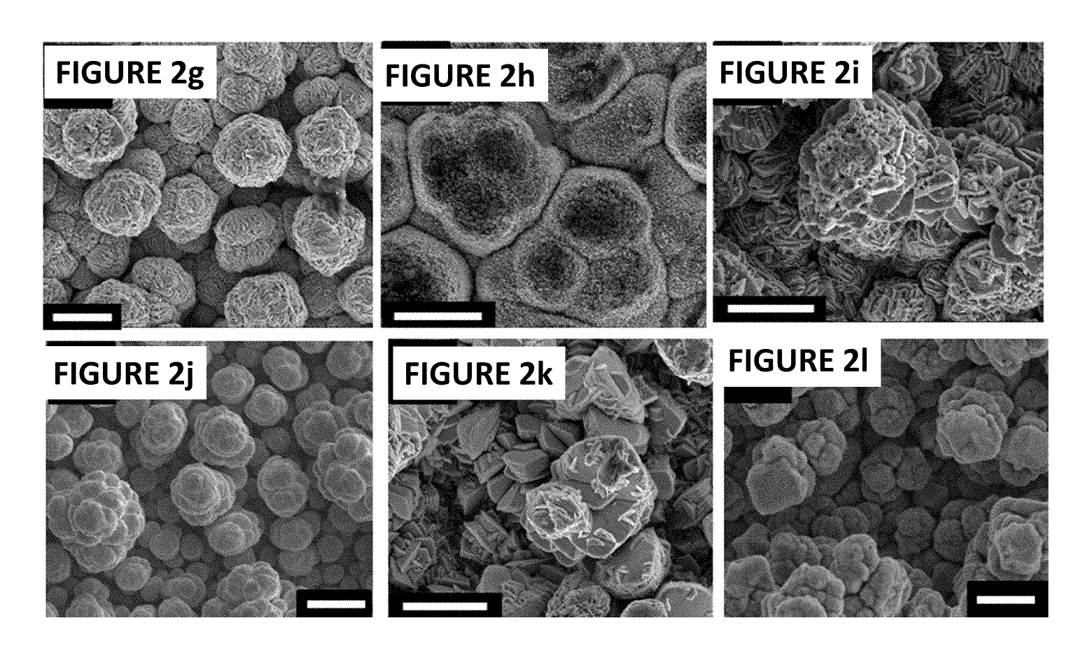

In certain examples, the textured layers described herein may comprise at least one metal or metallic compound. Examples of some of the metals which can be used include, but are not limited, to Nickel (Ni), Zinc (Zn), Chromium (Cr), Copper (Cu), Zinc/Nickel alloy (Zn/Ni), Zinc/Copper alloy (Zn/Cu), and other transition metals and combinations thereof. Examples of metallic compounds include, but are not limited to, metal oxides, metal carbides, metal nitrides, metal hydroxides, metal carbonitrides, metal oxynitrides, metal borides, metal borocarbides, metal fluorides, other metal compounds, or any combination thereof. Energy-dispersive (EDS) X-ray spectroscopy or any other analytical techniques can be used to show the presence of metal or metallic compound in the textured layer. For example, FIGS. 3a-c show the EDS spectroscopy results of three of the disclosed textured layers. EDS measures the number and energy of the X-rays emitted from a specimen. This energy is the characteristic of different species in that specimen. Therefore, EDS allows the elemental composition of the specimen to be measured. The vertical axis in FIGS. 3a-c is the counts of X-ray emission from different species. The EDS results of FIGS. 3a-c confirm that each textured layer comprises at least one metal or metallic compound. The textured layer corresponding to FIG. 3a comprises two metallic species of zinc and chromium, the one corresponding to FIG. 3b comprises nickel, and the last one in FIG. 3c comprises zinc.

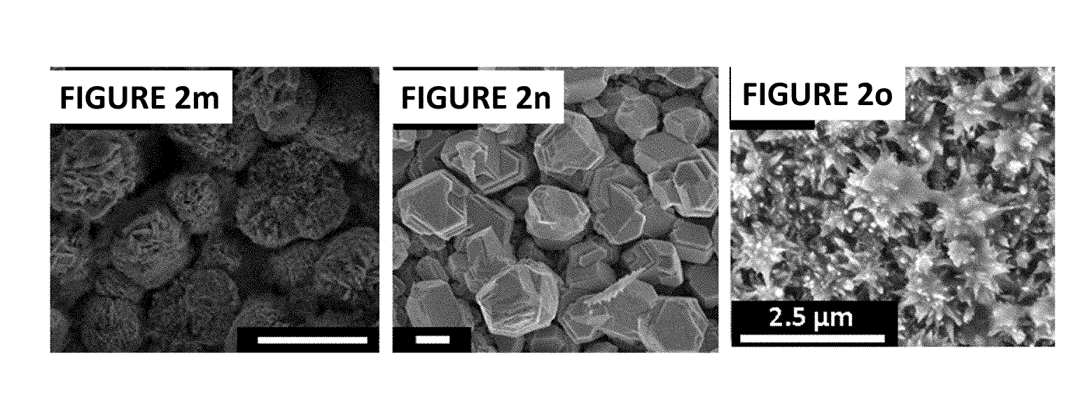

In certain configurations, the textured layers described herein may provide hydrophobic characteristics without any additional chemical treatment. It is worth mentioning that certain physical treatments may be performed to make the textured layer hydrophobic. For example, a water contact angle of greater than 90° is desirably provided using the coatings described herein. In addition, a superhydrophobic coating is defined as a coating which provides a water contact angle of more than 150°. Water contact angle can be measured using contact angle measurement equipment based on the ASTM D7490-13 standard. This angle is conventionally measured through the droplet, where the water-air interface meets the solid surface. A Kruss-582 system can be used to obtain the contact angle data. The water droplet shown in FIG. 4c is the representation of the water droplet contact with the textured layer shown in FIG. 1a. The water contact angle (WCA) of around 164°±2.64° was measured for this textured layer. The coating shown in FIG. 4c is considered to be superhydrophobic since its WCA is more than 150°. The WCA of this coating can be compared with the WCAs of 75° and 109.2° for a non-textured coating made of the same material and Teflon® in FIGS. 4a and 4b, respectively. These results are consistent with the showing that a proper surface texture can provide an increase in the WCAs of intrinsically hydrophilic materials to a value higher than one of the most commonly used non-stick coatings in the industry, e.g., a Teflon® coating. In certain examples, the exact properties of the coatings described herein may vary depending on the materials present and the methods used to produce the coatings.

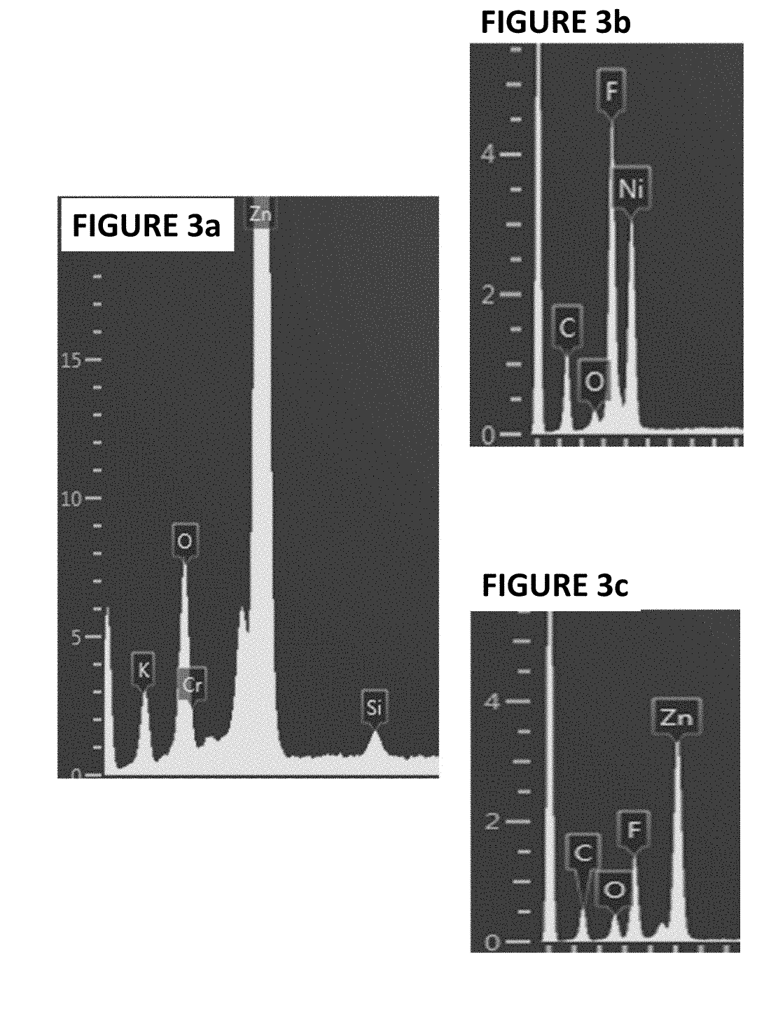

Without wishing to be bound by any particular theory, the effect of texture on the hydrophobic properties of a surface can be explained, for example, by the schematic image of a water droplet brought into contact with a textured surface in FIG. 5a. As shown in the inset of FIG. 5a, air is trapped in void spaces between microscale and nanoscale structures and protects the surface against wetting. Since air is an absolute hydrophobic material, this air trapping results in enhancing the hydrophobic property of the surface and a large contact angle (θ₁) shown in FIG. 5a is formed. This behavior can be compared with the interaction of a water droplet with a non-textured surface shown in the schematic image of FIG. 5b. As observed in the inset of FIG. 5b, a water droplet completely wets the surface. Moreover, on the non-textured surface a smaller contact angle than that shown in FIG. 5a is formed (θ₂<θ₁). By using the materials and processes described herein, packing of micro- and nano-structures together to trap air between the tightly packed structures can further enhance hydrophobicity of the coatings.

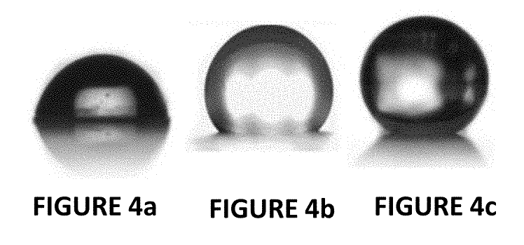

In another embodiment, a process for making a coating on a substrate may comprise one or more electrodeposition techniques comprising the steps shown in FIG. 6. The electrodeposition technique desirably provides the formation of a textured coating which comprises some or all of the characteristics or features described herein, e.g., is hydrophobic and/or comprises a large water contact angle. As FIG. 6 shows the electrodeposition technique may include following steps: providing an electrolyte mixture at a step 620. Possible composition of this mixture is discussed later in this disclosure; cleaning or activating the substrate and placing that in the electrolyte mixture can be performed at a step 630. An anode can be provided at a step 610 and used to deposit the coating. This disclosure is not bound by the type of the substrate or the method of the cleaning or activation process. Further information about the substrate is provided later in this disclosure. Different cleaning processes including but not limited to pickling, acid wash, saponification, vapor degreasing, and alkaline wash may be used for cleaning the substrate. The activation process may include but not limited to removal of the inactivate oxides by acid wash or pickling and catalytic deposition of a seed layer; providing an anode. This disclosure is again not limited on the shape and material of the anode. Further information about the anode is provided below; if desired, depositing optional intermediate layers can be performed at a step 640; depositing the disclosed textured layer by applying process conditions in the bath can be performed at a step 650. The range of these conditions will be discussed below. The substrate can be removed from the bath 660, and optional additional processes at step 670 can be performed—these processes may include different physical or chemical treatments and will be discussed in more detail herein.

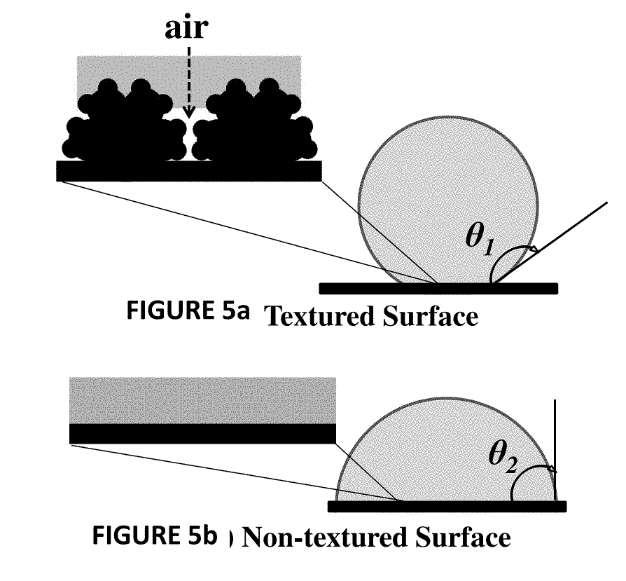

In certain examples, FIG. 7 shows an illustration of an electrodeposition device/system which can be used. The system 700 comprises three main components: an electrolyte 710, a negative electrode or cathode 720, and a positive electrode or anode 730. A substrate can be a part of the cathode 720. Both the cathode 720 and anode 730 can be placed in the electrolyte mixture 710. When electricity is applied, the substrate becomes negatively-charged and attracts positively-charged agents in the solution 710. A constant, multistep or varying voltage or current can be applied in the electroplating process to control or enhance the resulting coating properties. As a result of applying electricity, positively-charged agents are reduced or neutralized on the substrate and provide the textured layer. As a non-limiting example, a constant voltage in the range of −1 V to −10 V can be applied. As another non-limiting example a constant current in the range of −0.01 to −0.1 mA/cm² can be applied. The other non-limiting example is applying a varying voltage that alternates or swipes between the open circuit potential and a high voltage beyond the initiation of gas formation during the electrodeposition process. The electrolyte 710 is an aqueous mixture of different components. At least one of these components can be a positively-charged agent that is reduced by applying a voltage or current and gets deposited on the negative electrode. This deposit forms, at least in part, the textured coating layer. Other components of the electrolyte 710 may also get entrapped in the structure of the textured layer during the electrodeposition process. The electrodeposition process may be performed at a temperature ranging from 25 to 95° C. Moreover, the electrodeposition may be performed under non-agitation or agitation condition with the agitation rate of 0 to 800 rpm.

In addition to positively-charged agents, electrolyte 710 can consist of other compounds including, but not limited to, ionic compounds such as negatively-charged agents to enhance electrolyte conductivity, buffer compounds to stabilize electrolyte pH, and different additives. Examples of natively-charged agents, include but are not limited to, bromide (Br⁻), carbonate (CO₃⁻), hydrogen carbonate (HCO₃⁻), chlorate (ClO₃⁻), chromate (CrO4⁻), cyanide (CN⁻), dichromate (Cr₂O₇²⁻), dihydrogenphosphate (H₂PO₄⁻), fluoride (F⁻), hydride (H⁻), hydrogen phosphate (HPO₄²⁻), hydrogen sulfate or bisulfate (HSO₄⁻), hydroxide (OH⁻), iodide (I⁻), nitride (N³⁻), nitrate (NO₃⁻), nitrite (NO₂⁻), oxide (O₂⁻), permanganate (MnO₄⁻), peroxide (O₂²⁻), phosphate (PO₄³⁻), sulfide (S²⁻), thiocyanate (SCN⁻), sulfite (SO₃²⁻), sulfate (SO₄²⁻), chloride (Cl⁻), boride (B³⁻), borate (BO₃³⁻), disulfide (S₂²⁻), phosphanide (PH₂⁻), phosphanediide (PH²⁻), superoxide (O₂⁻), ozonide (O₃⁻), triiodide (I₃⁻), dichloride (Cl₂⁻), dicarbide (C₂²⁻), azide (N₃⁻), pentastannide (Sn₅²⁻), nonaplumbide (Pb₉⁴⁻), azanide or dihydridonitrate (NH₂⁻), germanide (GeH₃⁻), sulfanide (HS⁻), sulfanuide (H₂S⁻), hypochlorite (ClO⁻), hexafluoridophosphate ([PF₆]⁻), tetrachloridocuprate(II) ([CuCl₄]²⁻), tetracarbonylferrate ([Fe(CO)₄]²⁻), hydrogen(nonadecaoxidohexamolybdate) (HMo₆O₁₉⁻), tetrafluoroborate ([BF₄⁻]), Bis(trifluoromethylsulfonyl)imide ([NTf₂]⁻), trifluoromethanesulfonate ([TfO]⁻), Dicyanamide [N(CN)₂]⁻, methylsulfate [MeSO₄]⁻, dimethylphosphate [Me₂PO₄]⁻, acetate [MeCO₂]⁻, other similar groups, or any combination thereof.

In addition to the positively- and negatively charged agents, the electrolyte 710 can also comprise one or several additives. Illustrative examples of additives, include are but not limited to, thiourea, acetone, ethanol, cadmium ion, chloride ion, stearic acid, ethylenediamine dihydrochloride, saccharin, cetyltrimethylammonium bromide (CTAB), sodium dodecyl sulfate, ethyl vanillin, ammonia, ethylene diamine, polyethylene glycol (PEG), bis(3-sulfopropyl)disulfide (SPS), Janus green B (JGB), azobenzene-based surfactant (AZTAB), the polyoxyethylene family of surface active agents, sodium citrate, perfluorinated alkylsulfate, additive K, calcium chloride, ammonium chloride, potassium chloride, boric acid, myristic acid, choline chloride, citric acid, any redox active surfactant, any conductive ionic liquids, any wetting agents, any leveling agent, any defoaming agent, any emulsifying agent or any combination thereof. Examples of wetting agents include, but are not limited, to polyglycol ethers, polyglycol alcohols, sulfonated oleic acid derivatives, sulfate form of primary alcohols, alkylsulfonates, alkylsulfates aralkylsulfonates, sulfates, Perfluoro-alkylsulfonates, acid alkyl and aralkyl-phosphoric acid esters, alkylpolyglycol ether, alkylpolyglycol phosphoric acid esters or their salts, or any combination thereof. Examples of leveling agents include but not limited to N-containing and optionally substituted and/or quaternized polymers, such as polyethylene imine and its derivatives, polyglycine, poly(allylamine), polyaniline (sulfonated), polyvinylpyrrolidone, polyvinylpyridine, polyvinylimidazole, polyurea, polyacrylamide, poly(melamine-co-formaldehyde), polyalkanolamines, polyaminoamide and derivatives thereof, polyalkanolamine and derivatives thereof, polyethylene imine and derivatives thereof, quaternized polyethylene imine, poly(allylamine), polyaniline, polyurea, polyacrylamide, poly(melamine-co-formaldehyde), reaction products of amines with epichlorohydrin, reaction products of an amine, epichlorohydrin, and polyalkylene oxide, reaction products of an amine with a polyepoxide, polyvinylpyridine, polyvinylimidazole, polyvinylpyrrolidone, or copolymers thereof, nigrosines, pentamethyl-para-rosaniline, or any combination thereof. Examples of defoaming agents include but not limited to fats, oils, long chained alcohols or glycols, alkylphosphates, metal soaps, special silicone defoamers, commercial perfluoroalkyl-modified hydrocarbon defoamers and perfluoroalkyl-substituted silicones, fully fluorinated alkylphosphonates, perfluoroalkyl-substituted phosphoric acid esters, or any combination thereof. Examples of emulsifying agents include but not limited to cationic-based agents such as the alkyl tertiary heterocyclic amines and alkyl imidazolinium salts, amphoteric-based agents such as the alkyl imidazoline carboxylates, and nonionic-based agents such as the aliphatic alcohol ethylene oxide condensates, sorbitan alkyl ester ethylene oxide condensates, and alkyl phenol ethylene oxide condensates.

In some instances, the electrolyte mixture may also comprise a pH adjusting agent selected from a group including but not limited to inorganic acids, ammonium bases, phosphonium bases, or any combination thereof. The pH of the electrolyte mixture can be adjusted to a value within the range of 3 to 10 using these pH adjusting agents. The electrolyte can also include nanoparticles that can get entrapped in the textured layer. Examples of nanoparticles include but not limited to PTFE particles, silica (SiO₂) particles, alumina particles (Al₂O₃), silicon carbide (SiC), diatomaceous earth (DE), boron nitride (BN), titanium oxide (TiO₂), diamond, particles formed from differential etching of spinodally decomposed glass, single wall carbon nanotubes (SWCNTs), multi-wall carbon nanotubes (MWCNTs), platinum oxide (PtO₂), other nanoparticles, any chemically or physically modified versions of the foregoing particles, or any combination thereof.

As a non-limiting example, a textured copper layer can be electrodeposited from an aqueous solution comprising Cu²⁺, SO₄²⁻, H⁺, other charged agents, or additives. As another non-limiting example, a textured zinc layer can be electrodeposited from an aqueous solution comprising Zn²⁺, Cl⁻, BO₃³⁻, H⁺, K⁺, other charged agents, or additives.

In certain examples, the substrate or the base article of the coating can be a part of cathode 720. In FIG. 7, the substrate is schematically depicted as a flat plate; however, it can have different shapes. As an instance, the substrate can be a part of a tube or an object with any regular or irregular geometry. The substrate can be made of any material that can get electroplated including metals, alloys, plastics, composites, and ceramics. An intermediate layer can be applied between the substrate and the electrodeposited coating. The substrate can be conductive or non-conductive. However, for non-conductive substrates an intermediate activation layer or seed layer may be applied before the electrodeposition process.

In some embodiments, in a two-electrode electrodeposition process, such as that depicted in FIG. 7, the anode 730 is the reference of the voltage. It is also possible to provide a third electrode as a voltage reference. In FIG. 7, the anode 730 is schematically depicted as a flat plate; however, it can have different shapes. As an instance, it can be in the shape of pallets, mesh, bar, cylinder or it can be a part of an object with any regular or irregular geometry. The anode 730 can gradually dissolve during the electrodeposition process and contribute in replenishing the positively charged-ions in the electrolyte. As a non-limiting example, zinc and nickel plates can be used in the zinc and nickel electrodeposition process, respectively. Some anodes such as those made of platinum or titanium remain intact during the electrodeposition process.

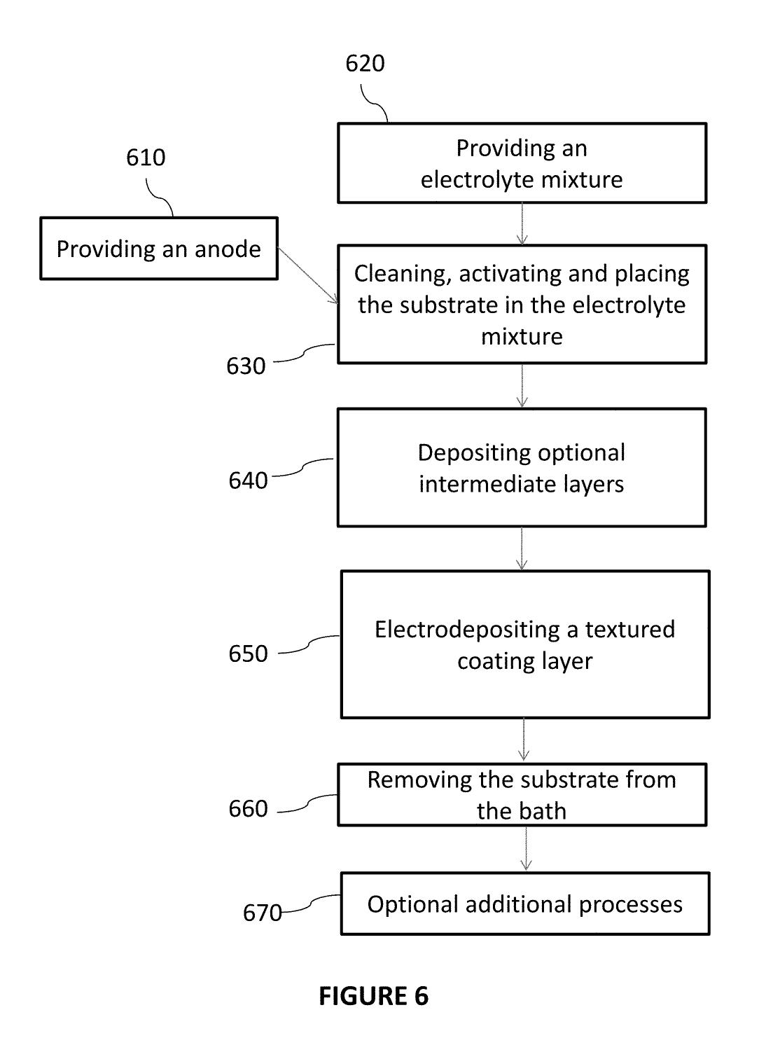

In certain examples and while not wishing to be bound by any particular theory, the formation of the surface textures by electrodeposition can be understood from the following non-limiting explanation The electroplating process is based on a nucleation and growth mechanism. Non-homogeneous conditions during the nucleation and growth process can result in the formation of textures on the surface of the growing material layer. When the conditions of the growth are not homogeneous, different locations of the surface encounter different growth rates. Some locations grow faster and form peaks while others grow slower and become valleys. This presence of these different resulting features provide for a surface texture on the substrate. In electroplating, different parameters such as voltage, bath composition, agitation, and bath temperature can be adjusted to control the level of non-homogeneity in the nucleation and growth process, and therefore, make different surface textures. In some instances, the electroplating conditions can be altered during surface coating formation to promote the formation of the textures surfaces. The effects of the process parameters on the deposit surface texture can be better understood by the following non-limiting explanation on the effects of voltage and bath composition. In some examples, the applied voltage can be controlled or tuned during coating to promote formation of textured surfaces. The effect of the applied voltage can be explained by unstable growth theories such as Mullins-Sekerka instability model (see, for example, Mullins and Sekerka, Journal of Applied Physics, Volume 35, Issue 2 (2004). Based on these theories, diffusional mass transfer favors the growth of the arbitrary protrusions of the surface and enhances the morphological instabilities or texture of the growing surface. The effect of the diffusional mass transfer on the formation and enhancement of surface texture can be explained with reference to FIG. 8a. This figure illustrates a recently-formed protrusion on a growing surface. This protrusion has a smaller height than the diffusion layer thickness and falls completely inside the diffusion layer (h<δ). Tip of this protrusion falls into the spherical diffusion regime while other parts of the surface are still under the linear diffusion regime. Since the rate of the spherical diffusion is greater than the rate of linear diffusion, the protrusion grows faster than the other parts of the surface. As shown in FIG. 8b, when the protrusion becomes large enough, smaller protrusions grow on top of that. The diffusion at the tip of these smaller protrusions is faster than the primary protrusion. This irregular growth can lead to other consecutive layers of smaller protrusions and may result in the formation of a hierarchical structure. By controlling the applied voltage, desired growth rates and effects for the surface textures can be achieved.

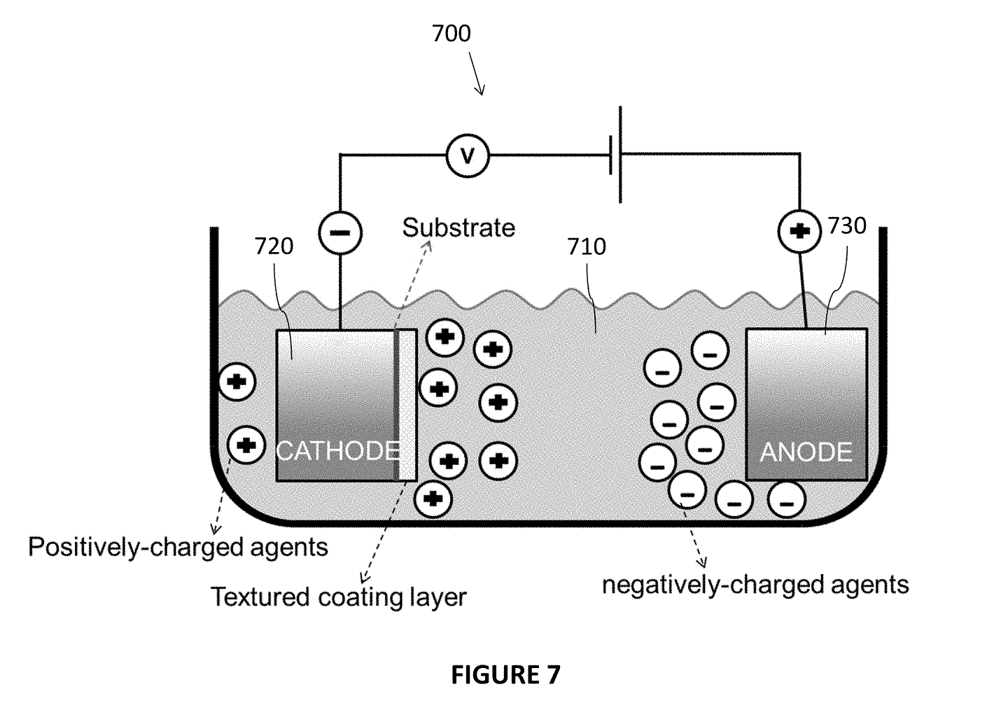

In certain configurations, similar to the applied voltage, the concentration of different species on the electrolyte can also affect the level of diffusional mass transfer in the bath and, therefore, can have an effect on the deposited surface textures. In addition to this effect, bath composition can have other interesting effects on the deposit surface texture, which is called the additive effect. The additive effect refers to the effect of a chemical reagent on making non-homogeneous growth conditions and subsequently forming a surface texture. Different chemical reagents undergo different mechanisms to promote the non-homogeneous growth condition. One of these mechanisms is shown in FIG. 9. In this mechanism, additive reagent restricts crystal growth in specific directions and results in a non-homogeneous growth process and texture formation. For instance, the additive shown in FIG. 9 restricts the growth process in the horizontal direction and results in the formation of conical structures. This type of additive reagents is called a crystal modifier. Crystal modifiers kinetically control the growth rates of different crystalline faces of metal particles by interacting with these faces through adsorption and desorption. Coordinating reagents are another group of additives that can promote non-homogeneous growth conditions and form surface textures. These additives form complexes with some of the metal ions. The other ions remain free in the solution. The presence of two different types of metal ions (free ions and ions involved in complexation) results in a non-homogeneous growth condition and can promote texture formation.

In certain examples, the exact attributes and properties of the coatings described herein can vary depending on the particular materials which are present, the coating conditions used, etc. In some examples, the surface features of the textured layer of the coatings may exhibit a hierarchical structure. Hierarchical structure refers to the condition where each surface feature comprises smaller features. The textured layers shown in FIGS. 1a-b are examples of hierarchical structures. For example, the small constituent features of this hierarchical structure are shown in the high-magnification micrograph of one of the surface features in FIG. 1b. The size of surface features in hierarchical structures can desirably be at least two times larger than their constituent features. As a prophetic example, the first feature size might be 10 microns while the second feature size is 1 micron. Based on this explanation, all textured layers shown in FIGS. 2a-m and FIG. 2o can be referred to as hierarchical structures. In contrast, the surface features in FIG. 2n do not comprise smaller features, and therefore, the textured layer shown in this figure is not considered a hierarchical structure.

In certain instances, the textured layer can comprise a composite of metals or metallic compound and nanoparticles. Nanoparticles can be selected from the group consisting of PTFE particles, silica (SiO₂) particles, alumina particles (Al₂O₃), silicon carbide (SiC), diatomaceous earth (DE), boron nitride (BN), titanium oxide (TiO₂), platinum oxide (PtO₂), diamond, particles formed from differential etching of spinodally decomposed glass, single wall carbon nanotubes (SWCNTs), mix silicon/titanium oxide particles (TiO₂/SiO₂, titanium inner core/silicon outer surface), ceramic particles, thermo-chromic metal oxide, multi-wall carbon nanotubes (MWCNTs), any chemically or physically modified versions of the foregoing particles, and any combination thereof.

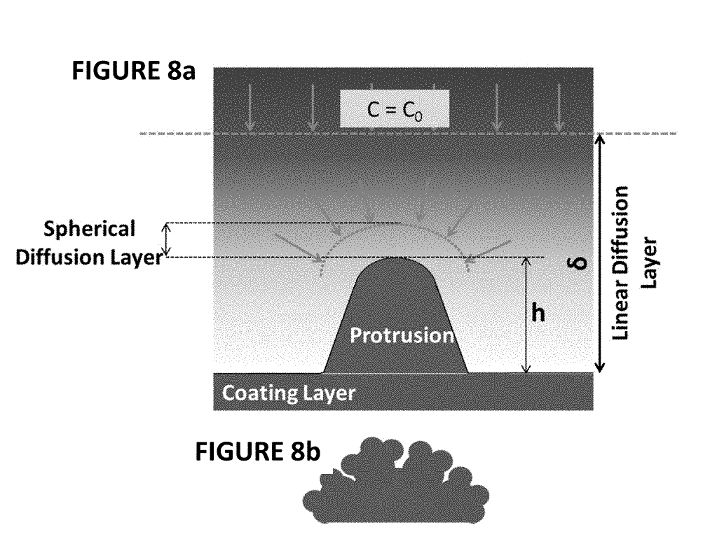

In certain configurations, in addition to the textured layer, the coating can comprise other layers as well. Each coating layer can be distinguished from its top and underneath layers by its different composition. Two adjacent layers might have distinct or indistinct interfaces. Two examples of multiple-layer coatings are discussed below. In a first example, the condition wherein one or multiple conformal coating layers are present on top of the textured layer is described. Conformal layers are defined as the coating layers that approximately follow the surface texture of their underneath layer (see FIGS. 10a, 10b and 10c). The conformal coating layer can comprise one or more of Chromium Nitride (CrN), Diamond Like Carbon (DLC), Titanium Nitride (TiN), Titanium Carbo-nitride (TiCN), Aluminum Titanium Nitride (ALTiN), Aluminum Titanium Chromium Nitride (AlTiCrN), Zirconium Nitride (ZrN), Nickel, gold, PlasmaPlus®, Cerablack™, Chromium, Nickel Fluoride (NiF₂), any Nickel Composite, any organic or inorganic-organic material and combinations thereof. Examples of nickel composites suitable for use as the conformal coating include, but are not limited to, composites of nickel with different particles selected from a group consisting of PTFE, silica (SiO₂), alumina (Al₂O₃), silicon carbide (SiC), diamond, diatomaceous earth (DE), boron nitride (BN), titanium oxide (TiO2), single wall carbon nanotubes (SWCNTs), multi-wall carbon nanotubes (MWCNTs), kaoline (Al₂O₃.2SiO₂.2H₂O), graphite, other nanoparticles, or any combination thereof. Examples of organic or inorganic-organic materials suitable for use as the conformal coating include, but are not limited to, parylene, organofunctional silanes, fluorinated alkylsilane, fluorinated alkylsiloxane, organofunctional resins, hybrid inorganic organofunctional resins, organofunctional polyhedral oligomeric silsesquioxane (POSS), hybrid inorganic organofunctional POSS resins, silicone polymers, fluorinated oligomeric polysiloxane, organofunctional oligomeric poly siloxane, fluorinated organofunctional silicone copolymers, organofunctional silicone polymers, hybrid inorganic organofunctional silicone polymers, organofunctional silicone copolymers, hybrid inorganic organofunctional silicone copolymers, fluorinated polyhedral oligomeric silsesquioxane (FPOSS), Dynasylan® SIVO, other similar groups, or any combination thereof.

In some instances, organofunctional silanes are a group of compounds that combine the functionality of a reactive organic group with inorganic functionality in a single molecule. This special property allows them to be used as molecular bridges between organic polymers and inorganic materials. The organic moiety of the silane system can be tailored with different functionalities consisting amino, benzylamino, benzyl, chloro, fluorinated alkyl/aryl, disulfido, epoxy, epoxy/melamine, mercapto, methacrylate, tetrasulfido, ureido, vinyl, vinyl-benzyl-amino, and any combination thereof. While any of these groups can be used application of the following groups is more common: amino, chloro, fluorinated alkyl/aryl, vinyl, and vinyl-benzyl-amino. The examples of aminosilane system are n-(3-acryloxy-2-hydroxypropyl)-3-aminopropyltriethoxysilane, n-(n-acetylleucyl)-3-aminopropyltriethoxysilane, 3-(n-allylamino)propyltrimethoxysilane, 4-aminobutyltriethoxysilane, 4-amino-3,3-dimethylbutylmethyldimethoxysilane, 4-amino-3,3-dimethylbutyltrimethoxysilane, aminoneohexyltrimethoxysilane, 1-amino-2-(dimethylethoxysilyl)propane, n-(2-aminoethyl)-3-aminoisobutyldimethylmethoxysilane, n-(2-aminoethyl)-3-aminoisobutylmethyldimethoxysilane, (aminoethylaminomethyl)phenethyltrimethoxysilane, n-(2-aminoethyl)-3-aminopropylmethyldiethoxysilane, n-(2-aminoethyl)-3-aminopropylmethyldimethoxysilane, n-(2-aminoethyl)-3-aminopropyltrimethoxysilane-propyltrimethoxysilane, oligomeric co-hydrolysate, n-(2-aminoethyl)-2,2,4-trimethyl-1-aza-2-silacyclopentane, n-(6-aminohexyl)aminomethyltriethoxysilane, n-(2-aminoethyl)-11-aminoundecyltrimethoxysilane, 3-(m-aminophenoxy)propyltrimethoxysilane, m-aminophenyltrimethoxysilane, p-aminophenyltrimethoxysilane, aminophenyltrimethoxysilane, n-3-[(amino(polypropyleneoxy)]aminopropyltrimethoxysilane, 3-aminopropyldiisopropylethoxysilane, 3-aminopropyldiisopropylethoxysilane, 3-aminopropyldimethylethoxysilane, 3-aminopropyldimethylfluorosila, n-(3-aminopropyldimethylsilyl)aza-2,2-dimethyl-2-silacyclopentane, 3-aminopropylmethyldiethoxysilane, 3-aminopropyltris(methoxyethoxyethoxy)silane, 11-aminoundecyltriethoxysilane, n-(2-n-benzylaminoethyl)-3-aminopropyltrimethoxysilane, n,n-bis(2-hydroxyethyl)-3-aminopropyltriethoxysilane, bis(trimethylsilyl)-3-aminopropyltrimethoxysilane, n-butylaminopropyltrimethoxysilane, t-butylaminopropyltrimethoxysilane, (n-cyclohexylaminomethyl) methyldiethoxysilane, (n-cyclohexylaminopropyl)trimethoxysilane, (n,n-diethylaminomethyl)triethoxysilane, (n,n-diethyl-3-aminopropyl)trimethoxysilane, 3-(n,n-dimethylaminopropyl)aminopropylmethyldimethoxysilane, (n,n-dimethylaminopropyl)-aza-2-methyl-2-methoxysilacyclopentane, n,n-dimethyl-3-aminopropylmethyldimethoxysilane, 3-(1,3-dimethylbutylidene)aminopropyltriethoxysilane, (3-(n-ethylamino)isobutyl)methyldiethoxysilane, (3-(n-ethylamino)isobutyl)trimethoxysilane, n-methyl-n-trimethylsilyl-3-aminopropyltrimethoxysilane, (phenylaminomethyl)methyldimethoxysilane, n-phenylaminomethyltriethoxysilane, n-phenylaminopropyltrimethoxysilane, 3-(n-styrylmethyl-2-aminoethylamino)propyltrimethoxysilane hydrochloride, (3-trimethoxysilylpropyl)diethylenetriamine, (cyclohexylaminomethyl)triethoxy-silane, (n-methylaminopropyl)methyl(1,2-propanediolato)silane, n-(trimethoxysilylpropyl)ethylenediaminetriacetate, tripotassium salt, n-(trimethoxysilylpropyl)ethylenediaminetriacetate, trisodium salt, 1-[3-(2-aminoethyl)-3-aminoisobutyl]-1,1,3,3,3-pentaethoxy-1,3-disilapropane, bis(methyldiethoxysilylpropyl)amine, bis(methyldimethoxysilylpropyl)-n-methylamine, bis(3-triethoxysilylpropyl)amine, n,n′-bis[(3-trimethoxysilyl)propyl]ethylenediamine, tris(triethoxysilylpropyl)amine, tris(triethoxysilylmethyl)amine, bis[4-(triethoxysilyl)butyl]amine, tris[(3-diethoxymethylsilyl)propyl]amine, n-(hydroxyethyl)-n,n-bis(trimethoxysilylpropyl)amine, n-(hydroxyethyl)-n-methylaminopropyltrimethoxysilane, n-(3-methacryloxy-2-hydroxypropyl)-3-aminopropyltriethoxysilane, 3-(n-styrylmethyl-2-aminoethylamino)propyltrimethoxysilane, 3-(2,4-dinitrophenylamino)propyltriethoxysilane, 4-nitro-4(n-ethyl-n-trimethoxysilylcarbamato)aminoazobenzene, bis(diethylamino)dimethylsilane, bis(dimethylamino)diethylsilane, bis(dimethylamino)dimethylsilane, (diethylamino)trimethylsilane, (n,n-dimethylamino)trimethylsilane, tris(dimethylamino)methylsilane, n-butyldimethyl(dimethylamino)silane, n-decyltris(dimethylamino)silane, n-octadecyldiisobutyl(dimethylamino)silane, n-octadecyldimethyl(diethylamino)silane, n-octadecyldimethyl(dimethylamino)silane, n-octadecyltris(dimethylamino)silane, n-octyldiisopropyl(dimethylamino) silane, n-octyldimethyl(dimethylamino)silane, and any combination thereof. the examples of the benzylaminosilane system are n-(2-n-benzylaminoethyl)-3-aminopropyltrimethoxysilane, n-(2-n-benzylaminoethyl)-3-aminopropyltrimethoxysilane hydrochloride, n-benzylaminomethyltrimethylsilane, or any combination thereof. The example of benzylsilane system are benzyldimethylchlorosilane, benzyldimethylsilane, n-benzyl-n-methoxymethyl-n-(trimethylsilylmethyl)amine, benzyloxytrimethylsilane, benzyltrichlorosilane, benzyltriethoxysilane, benzyltrimethylsilane, bis(trimethylsilylmethyl)benzylamine, (4-bromobenzyl) trimethylsilane, dibenzyloxydiacetoxysilane, or any combination thereof. The examples of chloro and chlorosilane system are (−)-camphanyldimethylchlorosilane, 10-(carbomethoxy)decyldimethylchlorosilane, 10-(carbomethoxy)decyltrichlorosilane, 2-(carbomethoxy)ethylmethyldichlorosilane, 2-(carbomethoxy)ethyltrichlorosilane, 3-chloro-n,n-bis(trimethylsilyl)aniline, 4-chlorobutyldimethylchlorosilane, (chlorodimethylsilyl)-5-[2-(chlorodimethylsilyl)ethyl]bicycloheptane, 13-(chlorodimethylsilylmethyl)heptacosane, 11-(chlorodimethylsilyl)methyltricosane, 7-[3-(chlorodimethylsilyl)propoxy]-4-methylcoumarin, 2-chloroethylmethyldichlorosilane, 2-chloroethylmethyldimethoxysilane, 2-chloroethylsilane, 1-chloroethyltrichlorosilane, 2-chloroethyltrichlorosilane, 2-chloroethyltriethoxysilane, 1-chloroethyltrimethylsilane, 3-chloroisobutyldimethylchlorosilane, 3-chloroisobutyldimethylmethoxysilane, 3-chloroisobutylmethyldichlorosilane, 1-(3-chloroisobutyl)-1,1,3,3,3-pentachloro-1,3-disilapropane, 1-(3-chloroisobutyl)-1,1,3,3,3-pentaethoxy-1,3-disilapropane, 3-chloroisobutyltrimethoxysilane, 2-(chloromethyl)allyltrichlorosilane, 2-(chloromethyl)allyltrimethoxysilane, 3-[2-(4-chloromethylbenzyloxy)ethoxy]propyltrichlorosilane, chloromethyldimethylchlorosilane, chloromethyldimethylethoxysilane, chloromethyldimethylisopropoxysilane, chloromethyldimethylmethoxysilane, (chloromethyl)dimethylphenylsilane, chloromethyldimethylsilane, 3-(chloromethyl)heptamethyltrisiloxane, chloromethylmethyldichlorosilane, chloromethylmethyldiethoxysilane, chloromethylmethyldiisopropoxysilane, chloromethylmethyldimethoxysilane, chloromethylpentamethyldisiloxane, ((chloromethyl)phenylethyl)dimethylchlorosilane, ((chloromethyl)phenylethyl)methyldichlorosilane, ((chloromethyl)phenylethyl)methyldimethoxysilane, ((chloromethyl)phenylethyl)trichlorosilane, ((chloromethyl)phenylethyl)triethoxysilane, ((chloromethyl)phenylethyl)trimethoxysilane, chloromethylphenethyltris(trimethylsiloxy)silane, (p-chloromethyl)phenyltrichlorosilane, (p-chloromethyl)phenyltrimethoxysilane, chloromethylsilatrane, chloromethyltrichlorosilane, chloromethyltriethoxysilane, chloromethyltriisopropoxysilane, chloromethyltrimethoxysilane, chloromethyltrimethylsilane, 2-chloromethyl-3-trimethylsilyll-propene, chloromethyltris(trimethylsiloxy) silane, (5-chloro-1-pentynyl)trimethylsilane, chlorophenylmethyldichloro-silane, chlorophenyltrichlorosilane, chlorophenyltriethoxysilane, p-chlorophenyltriethoxysilane, p-chlorophenyltrimethylsilane, (3-chloropropoxy)isopropyldimethylsilane, (3-chloropropyl)(t-butoxy)dimethoxysilane, 3-chloropropyldimethylchlorosilane, 3-chloropropyldimethylethoxysilane, 3-chloropropyldimethylmethoxysilane, 3-chloropropyldimethyl silane, 3-chloropropyldiphenylmethylsilane, chloropropylmethyldichlorosilane, 3-chloropropylmethyldiethoxysilane, 3-chloropropylmethyldiisopropoxysilane, 3-chloropropylmethyldimethoxysilane, (3-chloropropyl)pentamethyldisiloxane, 3-chloropropyltrichlorosilane, 3-chloropropyltriethoxysilane, 3-chloropropyltrimethoxysilane, 3-chloropropyltrimethylsilane, 3-chloropropyltriphenoxysilane, 3-chloropropyltris(trimethylsiloxy)silane, 2-(4-chlorosulfonylphenyl)ethyltrichlorosilane, 2-(4-chlorosulfonylphenyl)ethyltrichlorosilane, 2-(4-chlorosulfonylphenyl)ethyltrimethoxysilane, 2-(4-chlorosulfonylphenyl)ethyltrimethoxysilane, 1-chloro-5-(trimethylsilyl)-4-pentyne, chlorotris(trimethylsilyl)silane, 11-chloroundecyltrichlorosilane, 11-chloroundecyltriethoxysilane, 11-chloroundecyltrimethoxysilane, 1-chlorovinyltrimethylsilane, (3-cyanobutyl)dimethylchlorosilane, (3-cyanobutyl)methyldichlorosilane, (3-cyanobutyl)trichlorosilane, 12-cyanododec-10-enyltrichlorosilane, 2-cyanoethylmethyldichlorosilane, 2-cyanoethyltrichlorosilane, 3-cyanopropyldiisopropylchlorosilane, 3-cyanopropyldimethylchlorosilane, 3-cyanopropylmethyldichlorosilane, 3-cyanopropylphenyldichlorosilane, 3-cyanopropyltrichlorosilane, 3-cyanopropyltriethoxysilane, 11-cyanoundecyltrichlorosilane, [2-(3-cyclohexenyl)ethyl]dimethylchlorosilane, [2-(3-cyclohexenyl)ethyl]methyldichlorosilane, [2-(3-cyclohexenyl)ethyl]trichlorosilane, 3-cyclohexen yltrichlorosilane, cyclohexyldimethylchlorosilane, cyclohexylmethyldichlorosilane, (cyclohexylmethyl)trichlorosilane, cyclohexyltrichlorosilane, (4-cyclo octenyl)trichlorosilane, cyclooctyltrichlorosilane, cyclopentamethylenedichlorosilane, cyclopentyltrichlorosilane, cyclotetramethylenedichlorosilane, cyclotrimethylenedichlorosilane, cyclotrimethylenemethylchlorosilane, 1,3-dichlorotetramethyldisiloxane, 1,3-dichlorotetraphenyldisiloxane, dicyclohexyldichlorosilane, dicyclopentyldichlorosilane, di-n-dodecyldichlorosilane, dodecylmethylsilyl)methyldichlorosilane, diethoxydichlorosilane, or any combination thereof. the examples of the epoxysilane system are 2-(3,4-epoxycyclohexyl) ethylmethyldiethoxysilane, 2-(3,4-epoxycyclohexyl) ethyltriethoxysilane, 2-(3,4-epoxycyclohexyl) ethyltrimethoxysilane, 5,6-epoxyhexyltriethoxysilane, (epoxypropyl)heptaisobutyl-T8-silsesquioxane, or any combination thereof. The example of mercaptosilane system are (mercaptomethyl)methyldiethoxysilan, 3-mercaptopropylmethyldimethoxysilane, 3-mercaptopropyltriethoxysilane, 3-mercaptopropyltrimethoxysilane, 3-mercaptopropyltrimethoxysilane, 3-mercaptopropyltrimethylsilane, 3-mercaptopropyltriphenoxysilane, 11-mercaptoundecyloxytrimethylsilane, 11-mercaptoundecyltrimethoxysilane, or any combination thereof. The examples of ureidosilane are ureidopropyltriethoxysilane, ureidopropyltrimethoxysilane, or any combination thereof. The examples of vinyl, vinylbenzylsilane system are vinyl(bromomethyl)dimethylsilane, (m,p-vinylbenzyloxy)trimethylsilane, vinyl-t-butyldimethylsilane, vinyl(chloromethyl)dimethoxysilane, vinyl(chloromethyl)dimethylsilane, 1-vinyl-3-(chloromethyl)-1,1,3,3-tetramethyldisiloxane, vinyldiethylmethylsilane, vinyldimethylchlorosilane, vinyldimethylethoxysilane, vinyldimethylfluorosilane, vinyldimethylsilane, vinyldi-n-octylmethylsilane, vinyldiphenylchlorosilane, vinyldiphenylethoxysilane, vinyldiphenylmethylsilane, vinyl(diphenylphosphinoethyl)dimethylsilane, vinyl(p-methoxyphenyl)dimethylsilane, vinylmethylbis(methylethylketoximino)silane, vinylmethylbis(methylisobutylketoximino)silane, vinylmethylbis(trimethylsiloxy)silane, vinylmethyldiacetoxysilane, vinylmethyldichlorosilane, vinylmethyldichlorosilane, vinylmethyldiethoxysilane, vinylmethyldimethoxysilane, 1-vinyl-1-methylsilacyclopentane, vinyloctyldichlorosilane, o-(vinyloxybutyl)-n-triethoxysilylpropyl carbamate, vinyloxytrimethylsilane, vinylpentamethyldisiloxane, vinylphenyldichlorosilane, vinylphenyldiethoxysilane, vinylphenyldimethylsilane, vinylphenylmethylchlorosilane, vinylphenylmethylmethoxysilane, vinylphenylmethylsilane, vinylsilatrane, vinyl-1,1,3,3-tetramethyldisiloxane, vinyltriacetoxysilane, vinyltri-t-butoxysilane, vinyltriethoxysilane, vinyltriethoxysilane, oligomeric hydrolysate, vinyltriethoxysilane-propyltriethoxysilane, oligomeric co-hydrolysate, vinyltriethylsilane, vinyl(trifluoromethyl)dimethylsilane, vinyl(3,3,3-trifluoropropyl)dimethylsilane, vinyltriisopropenoxysilane, vinyltriisopropoxysilane, vinyltrimethoxysilane, vinyltrimethoxysilane, oligomeric hydrolysate, vinyltrimethylsilane, vinyltriphenoxysilane, vinyltriphenylsilane, vinyltris(dimethylsiloxy)silane, vinyltris(2-methoxyethoxy)silane, vinyltris(1-methoxy-2-propoxy)silane, vinyltris(methylethylketoximino)silane, vinyltris(trimethylsiloxy)silane, or any combination thereof.

Illustrative examples of fluorinated alkyl/aryl silane include, but are not limited to, 4-fluorobenzyltrimethylsilane, (9-fluorenyl) methyldichlorosilane, (9-fluorenyl) trichlorosilane, 4-fluorophenyltrimethylsilane, 1,3-bis(tridecafluoro-1,1,2,2-tetrahydrooctyl)tetramethyldisiloxane, 1H,1H,2H,2H-perfluorodecyltrimethoxysilane, 1H,1H,2H,2H-perfluorodecyltrichlorosilane, 1H,1H,2H,2H-perfluorooctyltrichlorosilane, 1H,1H,2H,2H-perfluorooctadecyltrichlorosilane, 1H,1H,2H,2H-Perfluorooctyltriethoxysilane, 1H,1H,2H,2H-Perfluorododecyltrichlorosilane, Trimethoxy(3,3,3-trifluoropropyl)silane, tridecafluoro-1,1,2,2-tetrahydrooctyl-1-trimethoxysilane, tridecafluoro-1,1,2,2-tetrahydrooctyl-1-triethoxysilane, and any combination thereof.

Where an organofunctional resin is present, the organofunctional resin can be selected from the group consisting of epoxy, epoxy putty, ethylene-vinyl acetate, phenol formaldehyde resin, polyamide, polyester resins, polyethylene resin, polypropylene, polysulfides, polyurethane, polyvinyl acetate, polyvinyl alcohol, polyvinyl chloride (PVC), polyvinyl chloride emulsion (PVCE), polyvinylpyrrolidone, rubber cement, silicones, and any combination thereof. Organofunctional polyhedral oligomeric silsesquioxane (POSS) can be selected from the group consisting acrylates, alcohols, amines, carboxylic acids, epoxides, fluoroalkyls, halides, imides, methacrylates, molecular silicas, norbornenyls, olefins, polyethylenglycols (PEGs), silanes, silanols, thiols, and any combination thereof. Illustrative examples of acrylates POSS's include acryloisobutyl POSS, or any combination thereof. Illustrative examples of alcohols POSS are diol isobutyl POSS, Cyclohexanediol isobutyl POSS, Propanediol isobutyl POSS, Octa (3-hydroxy-3-methylbutyldimethylsiloxy) POSS, or any combination thereof. Illustrative examples of amines POSS are Aminopropylisobutyl POSS, Aminopropylisooctyl POSS, Aminoethylaminopropylisobutyl POSS, OctaAmmonium POSS, Aminophenylisobutyl POSS, Phenylaminopropyl POSS Cage Mixture, or any combination thereof. Illustrative examples of a Carboxylic Acids POSS are Maleamic Acid-Isobutyl POSS, OctaMaleamic Acid POSS, or any combination thereof. Illustrative examples of an epoxide are Epoxycyclohexylisobutyl POSS, Epoxycyclohexyl POSS Cage Mixture, Glycidyl POSS Cage Mixture, Glycidylisobutyl POSS, Triglycidylisobutyl POSS, Epoxycyclohexyl dimethylsilyl POSS, OctaGlycidyldimethylsilyl POSS, or any combination thereof. In the case of fluoroalkyl POSS examples are Trifluoropropyl POSS Cage Mixture, Trifluoropropylisobutyl POSS, or any combination thereof. In the case of halid POSS is Chloropropylisobutyl POSS, or any combination thereof. In the case of Imides POSS examples are POSS Maleimide Isobutyl, or any combination thereof. In the case of Methacrylates examples are Methacryloisobutyl POSS, Methacrylate Ethyl POSS, Methacrylate Isooctyl POSS, Methacryl POSS Cage Mixture, or any combination thereof. In the case of molecular silica POSS examples are DodecaPhenyl POSS, Isooctyl POSS Cage Mixture, Phenylisobutyl POSS, Phenylisooctyl POSS, Octaisobutyl POSS, OctaMethyl POSS, OctaPhenyl POSS, OctaTMA POSS, OctaTrimethylsiloxy POSS, or any combination thereof. In the case of Norbornenyls examples are NB1010—1,3-Bis(Norbornenylethyl)-1,1,3,3-tetramethyldisiloxane, Norbornenylethyldimethylchlorosilane, NorbornenylethylDiSilanolisobutyl POSS, Trisnorbornenylisobutyl POSS, or any combination thereof. In the case of Olefins example are Allyisobutyl POSS, Vinylisobutyl POSS, Vinyl POSS Cage Mixture, or any combination thereof. In the case of PEGs, examples include PEG POSS Cage Mixture, MethoxyPEGisobutyl POSS, or any combination thereof. In the case of a silane examples are OctaSilane POSS, or any combination thereof. In the case of silanols examples are DiSilanolisobutyl POSS, TriSilanolEthyl POSS, TriSilanolisobutyl POSS, TriSilanolisooctyl POSS, TriSilanolPhenyl POSS Lithium Salt, TrisilanolPhenyl POSS, TetraSilanolPhenyl POSS, or any combination thereof. In the case of thiols is Mercaptopropylisobutyl POSS, or any combination thereof.

In certain embodiments, another example of a coating comprises at least one additional layer comprising a lubricant, a polymer blend, nanoparticles, or any combination thereof, such as polymer-nanoparticle composite materials, that is infused inside the surface features of the textured layer. In this case the surface features can provide mechanical grips for the additional layer. Nanoparticles can either be treated with a low surface energy material in advance or a low surface energy material can be added to the chemical blend of the additional layer. High surface energy materials are more easily wet than low surface energy materials. Low surface energy materials usually exhibit a surface energy value less than 70 mJ/m² when measured according to the ASTM D7490-13 standard. Examples of low surface energy materials include but not limited to organofunctional silane, low-surface-energy resins, fluorinated alkylsiloxane, fluorinated alkylsilane, silicone polymers, organofunctional silicone polymers, organofunctional silicone copolymers, fluorinated polyhedral oligomeric silsesquioxane (FPOSS), Dynasylan® SIVO, organofunctional polyhedral oligomeric silsesquioxane (POSS), or any combination thereof. Examples of nanoparticles used in the structure of the additional layer include but not limited to silica (SiO₂), alumina (Al₂O₃), silicon carbide (SiC), diamond, diatomaceous earth (DE), boron nitride (BN), titanium oxide (TiO₂), single wall carbon nanotubes (SWCNTs), multi-wall carbon nanotubes (MWCNTs), kaolin (Al₂O₃.2SiO₂.2H₂O), or any combination thereof. In particular, nanoparticles can be hydrophobic ceramic-based particles selected from the group consisting of AEROSIL® brand from Evonik industries, the product of Dry Surface Technologies (DST) under Barrian™ brand, CAB-O-SIL® brand from Cabot Corporation, HDK® brand from WACKER, and any combination thereof.

In some instances, the polymer used in the structure of the additional layer can be selected from the group including but not limited to organic polymers, thermoplastic polymers, thermosetting polymers, copolymers, terpolymers, a block copolymer, an alternating block copolymer, a random polymer, homopolymer, a random copolymer, a random block copolymer, a graft copolymer, a star block copolymer, a dendrimer, a poly electrolyte (polymers that have some repeat groups that contains electrolytes), a poly ampholyte (Poly ampholytes are polyelectrolytes with both cationic and anionic repeat groups. There are different types of poly ampholyte. In the first type, both anionic and cationic groups can be neutralized. In the second type, anionic group can be neutralized, while cationic group is a group insensitive to pH changes such as a quaternary alkyl ammonium group. In the third type, cationic group can be neutralized and anionic group is selected from those species such as sulfonate groups that are showing no response to pH changes. In the fourth type, both anionic and cationic groups are insensitive to the useful range of pH changes in the solution.), ionomers (an ionomer is a polymer comprising repeat units of electrically neutral and ionized units. Ionized units are covalently bonded to the polymer backbone as pendant group moieties and usually consist mole fraction of no more than 15 mole percent), oligomers, cross-linkers, or any combination thereof. Examples of organic polymers include, but are not limited, to polyacetals, polyolefins, polyacrylics, polycarbonates, polystyrenes, polyesters, polyamids, polyamidimides, polyacrylates, polyarylsulfones, polythersulfones, polyphenylene sulfides, polyvinylchlorides, polysulfones, polyimides, polyetherimides, polytetrafluoroethylenes, polyether ketone ketones, polybenzoxazoles, polyphthalides, polyacetals, polyanhydrides, polyvinyl ethers, polyvinyl thioethers, polyvinyl alcohols, polyvinyl ketones, poly vinyl halides, polyvinyl nitriles, polyvinyl esters, polysulfonates, poly sulfides, polythioesters, polysulfones, polysulfonamides, polyureas, polyphosphazenes, polysilazanes, styrene acrylonitrile, acrylonitrile-butadiene-styrene (ABS), polyethylene terephthalate, polybutylene terephthalate, polyurethane, ethylene ptopylene diene rubber (EPR), perfluoroelastomers, fluorinated ethylene propylene, perfluoroalkoxyethylene, poly-chlorotrifluoroethylene, polyvinylidene fluoride, polysiloxanes, or any combination thereof. Examples of polyelectrolytes include, but are not limited to, polystyrene sulfonic acid, polyacrylic acid, pectin, carrageenan, alginates, carboxymethylcellulose, polyvinylpyrrolidone, or any combination thereof. Examples of thermosetting polymers include, but are not limited to, epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, urea-formaldehyde polymers, novolacs, resoles, melamine-formaldehyde polymers, urea-formaldehyde polymers, hydroxymethylfuranes, isocyanates, diallyl phthalate, triallyl cyanurate, triallyl isocyanurate, unsaturated polysterimides, or any combination thereof. Examples of thermoplastic polymers include, but are not limited to, acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, poly sulfone/acrylonitrile-butadiene-styrene, polycarbonate/thermoplastic urethane, polycarbonate/polybutylene terephthalate, thermoplastic elastomer alloys, nylon/elastomers, polyester/elastomers, polyethylene terephthalate/polybutylene terephthalate, acetal/elastomer, styrene maleic anhydride/acrylonitrile-butadiene-styrene, polyether etherketone/polyethersulfone, polyether, etherketone/polyetherimide polyethylene/nylon, polyethylene/polyacetal, or any combination thereof.

In certain examples, processes other than electropdeposition processes can also be used in production of the coatings. The hydrophobic textured layer can be made, for example, through a process comprising a combination of the electrodeposition techniques and any other technique selected from the group consisting of annealing and thermal processing, vacuum conditioning, aging, plasma etching, grit blasting, wet etching, ion milling, exposure to electromagnetic radiation such as visible light, UV, and x-ray, other processes, and combinations thereof. In addition, the manufacturing process of the hydrophobic textured layer can be followed by at least one additional coating process selected from the group consisting of electrodeposition, electroless deposition, surface functionalization, electro-polymerization, spray coating, brush coating, dip coating, electrophoretic deposition, reaction with fluorine gas, plasma deposition, brush plating, chemical vapor deposition, sputtering, physical vapor deposition, passivation through the reaction of fluorine gas, any other coating technique, and any combination thereof.

In certain instances, the coating can exhibit heat-resistant characteristics. This characteristic is observed if a water contact angle of the coating changes less than 20 percent after the coating is subjected to a thermal process at 100° C. or higher for 12 hours or longer. For example, the results of a heat-resistance test for the superhydrophobic coating shown in FIGS. 1a-b is now described. This test was performed at 572° F. (300° C.). This temperature is far beyond the temperature reported in the literature for Teflon® breakdown. It has been found that toxic fumes generated from Teflon® breakdown at 396° F. are enough to kill birds (see Boucher et al., Avian Diseases. Vol. 44, No. 2 (April-June, 2000), pp. 449-453). The thermal resistance of the coatings described herein can also be compared with a NeverWet® coating. A NeverWet® coating is a sol-gel based superhydrophobic coating that is commercially available. This coating is applied by a two-step spray system. The first step provides adhesion to the substrate through a base coat that is not hydrophobic. The superhydrophobic top layer is then sprayed on the first coating layer, in the second step. The superhydrophobic top layer of the NeverWet® coating was completely decomposed after 15 minutes at 572° F. The coating completely lost its superhydrophobic property and its color turned to black. In contrast, both the superhydrophobic property and the appearance of the zinc-based coating shown in FIGS. 1a-b remained intact after 24 hours at 572° F. Similar results were obtained by performing 24 series of repetitive hot and cold cycles at respective temperatures of 572° F. and 75° F. The coating also exhibits zero mass loss percentage after these high temperature experiments. These results are consistent with the coatings described herein as providing negligible off-gassing at high temperatures.

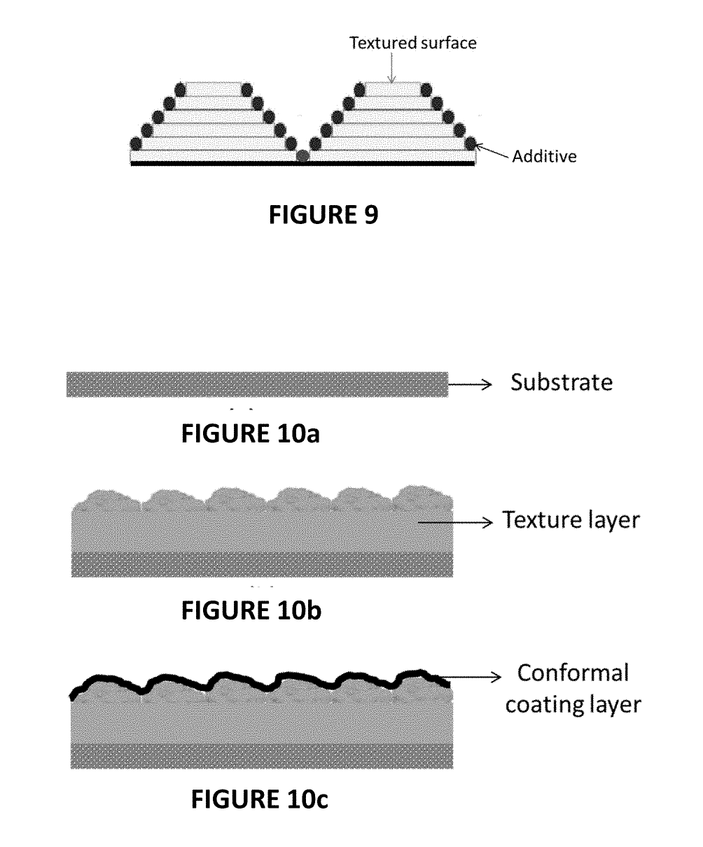

In certain embodiments, the coatings described herein can be considered mechanically durable. Mechanical durability can be defined based on two criteria of hardness and pull-off (tape) tests. The hardness criterion is defined based on the pencil hardness level of more than 3B corresponding to the ASTM D3363-05(2011)e2 standard measurement. This test method determines the hardness of a coating by drawing pencil lead marks from known pencil hardness on the coating surface. The film hardness is determined based on the hardest pencil that will not rupture or scratch the film. A set of calibrated drawing leads or calibrated wood pencils meeting the following scales of hardness were used: 9H-8H-7H-6H-5H-4H-3H-2H-H-F-HB-B-2B-3B-4B-5B-6B-7B-8B-9B. 9B grade corresponds to the lowest level of hardness and represents very soft coatings. The hardness level increases gradually after that until it gets to the highest level of 9H. The difference between two adjacent scales can be considered as one unit of hardness. As a non-prophetic example, a pencil hardness of 7H was obtained for the zinc-based superhydrophobic coating shown in FIGS. 1a-b. This level of hardness can be compared with that of the NeverWet® coating that corresponds to less than 9B. The hardness level of the superhydrophobic zinc-based coating is also much higher than the grade of HB that is reported for Teflon® coating by its manufacturer. As shown in FIGS. 11a (before testing) and 11b (after testing), a pencil hardness of 7H was obtained for the zinc-based coating. The hardness of this coating can be compared with that of the NeverWet® coating that corresponds to less than 9B (FIG. 11d). The hardness level of the zinc-based coating is also much higher than the grade of HB that is reported for Teflon® coating by its manufacturer. FIG. 11e provides a comparison for the hardness level of the produced zinc based coating with that of Teflon® and NeverWet® coatings.

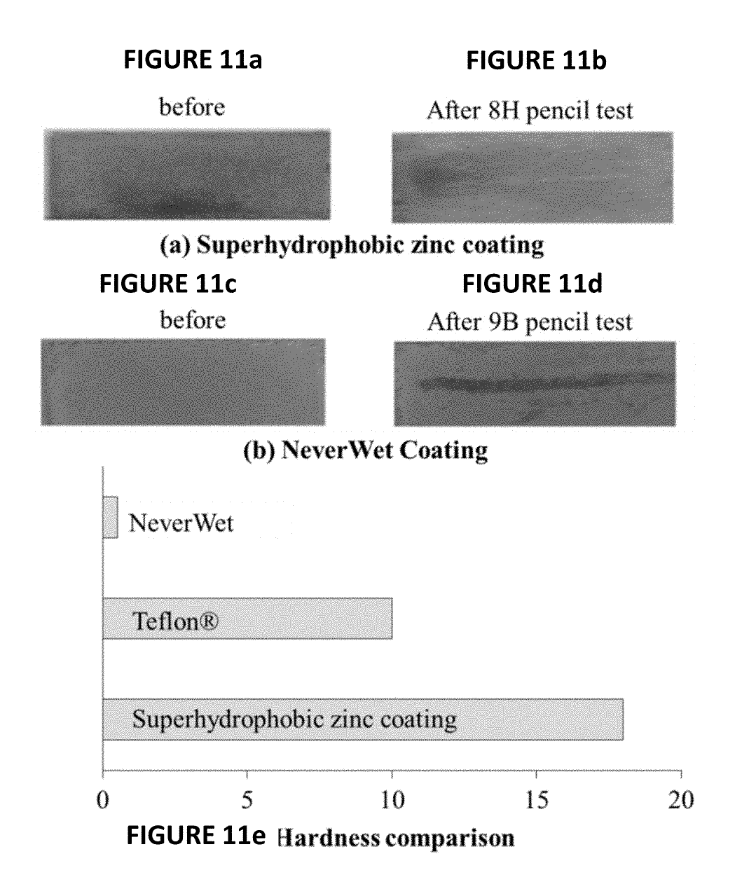

As another non-limiting example, a pencil hardness of 5H was obtained for a tested copper-based superhydrophobic coating. FIGS. 12a-b show the images of the copper-based superhydrophobic coating before (FIG. 12a) and after 5H pencil hardness test (FIG. 12b), respectively. Another non-limiting example is the composite superhydrophobic coating comprising copper and nickel with the pencil hardness of 9H. Images of this composite coating before and after the 9H pencil hardness test are shown in FIGS. 12c and d, respectively. No scratch is seen on the coating surface in FIG. 12d. Therefore, the hardness of the composite coating can be even higher than the maximum level of the pencil hardness test that is 9H.

In addition to the pencil hardness, durability of the coating can be characterized using the standard ASTM procedure for the tape test (ASTM F2452-04-2012). This attribute of durability is defined based on exhibiting at least level three of durability among five levels defined by the standard test. In this test, a tape is adhered to the surface and pulled away sharply. The level of the coating durability obtained based on the amount of the coating removed from the surface and attached to the tape. The lowest to highest durability is rated from 1 to 5, respectively. A lower rating means that some part of the coating was removed by the tape, and therefore, a part of the coating functionality was lost. Rate 5 corresponds to the condition that zero amount of coating is removed. Therefore, the functionally of the coating at this rate remains the same after and before the tape test.

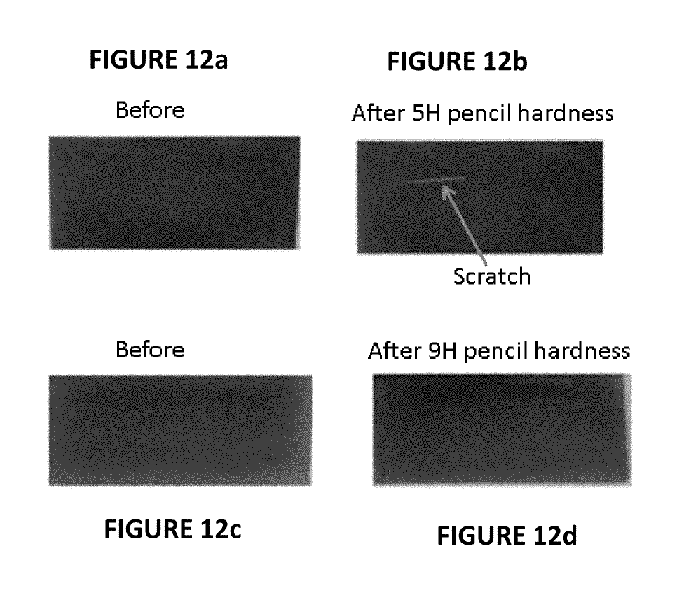

As a non-limiting example, FIGS. 13a-d show photographs of the tape after performing the pull-off test on the superhydrophobic zinc coating and the NeverWet® coating, respectively. As seen in these figures, no part of the superhydrophobic zinc coating (FIG. 13a) was transferred to the tape, while some part of the superhydrophobic top layer of the NeverWet® coating (FIG. 13b) is removed by the tape. Therefore, based on this test, the NeverWet® coating is less durable compared to the produced coating using this test methodology.

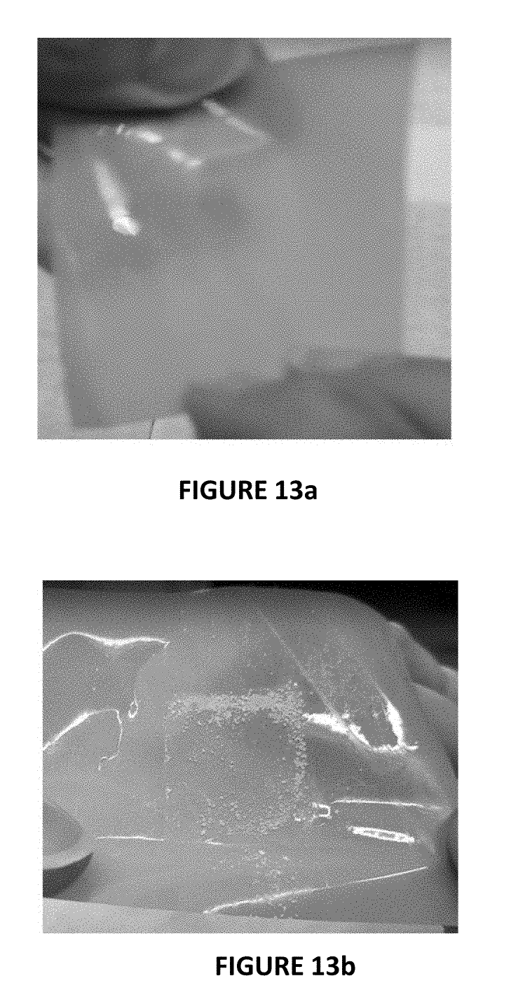

In addition to the pencil hardness and tape tests, a Tabor abrasion test is another test that can be performed on the coatings described herein. In this test, the coated samples were subjected to several cycles of abrasive wheels with 500 g loading weight at 60 rpm speed. The mass loss percentage (%) of the coatings was then calculated for each individual sample based on the ratio of mass loss to the initial mass of the coating. FIGS. 14a-b show the images of the zinc-based superhydrophobic coating before (FIG. 14a) and after FIG. 14b) 5 cycles of Tabor abrasion test, respectively. These images can be compared with those in FIGS. 14c-d that correspond to the NeverWet® coating before (FIG. 14c) and after (FIG. 14d) 5 cycles of Tabor abrasion test, respectively. As seen in FIG. 14d, the hydrophobic layer of the NeverWet® coating completely abraded at the locations subjected to the abrasion test. In fact, more than half of the initial layer was lost in this abrasion process. This result can be compared with the mass loss percentage of the superhydrophobic zinc-based coating which was less than 1%. As FIG. 14b shows, the zinc-based coating remained almost intact in this abrasion process. Moreover, in this test, the coating retained its superhydrophobic property. Abrasion resistance of textured superhydrophobic coatings is generally less than hydrophobic coatings that do not have any surface texture. These results are consistent with the described metal-based superhydrophobic coatings having a higher level of abrasion durability compared to conventional spray-based superhydrophobic coatings.

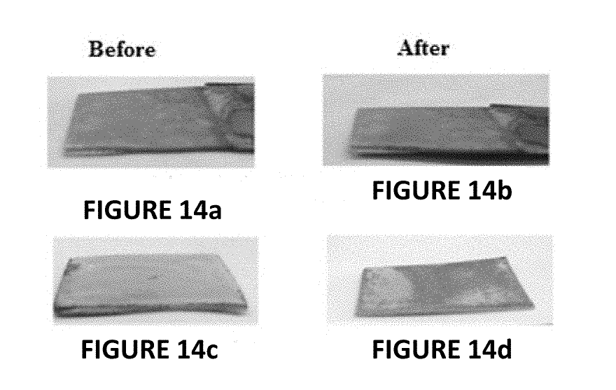

In some embodiments, the coating described herein may be considered easy-clean coatings. Easy-clean characteristic is defined, wherein in a cleanability test, at least 80 percent of the surface can be cleaned. In this test, the coating is painted with cooking oil and placed in an oven at 100° C. for 12 hours. It will then be wiped out with a wet tissue. Easy-clean characteristic is also related to the coating oleophobicity. The oleophobic characteristic can be measured by the contact angle of oil on a surface. As a non-limiting example, FIG. 15a exhibits the contact angle of cooking oil on the surface of one zinc-based coatings as described herein. This contact angle can be compared with the oil contact angle of a Teflon® coating in FIG. 15b. As shown in FIGS. 15a-b, the zinc coating exhibited higher levels of oleophobicity than the Teflon® coating.

Certain configurations of the coatings described herein can also provide one or more of the following attributes: reduce transfer from/to the surface, provide protection, prevent or discourage adhesion of water and microscale/nanoscale objects, or a combination of said functionalities. Certain coatings can be used in many different applications including but not limited to, wetting, dirt accumulation, corrosion, microbial adhesion and disease transformation, ice formation, friction and drag and biofouling prevention and/or mitigation. For instance, the coating can protect, to at least some degree, an article, e.g. vehicle or other components, against detrimental effects of the environment, e.g. corrosion and fouling, which reduce the overall useful lifetime of the article or cause fading or deterioration. The coating can be used in equipment with high-temperature working conditions such as ovens, heat-exchangers, and condensers. It can be used to mitigate sticky problems at high temperature environments. As another instance, certain configurations of coatings can discourage transfer of liquids, dirt, microorganisms, viruses, or particles from/to an article to/from human and animals upon contact, which can reduce cross contamination.

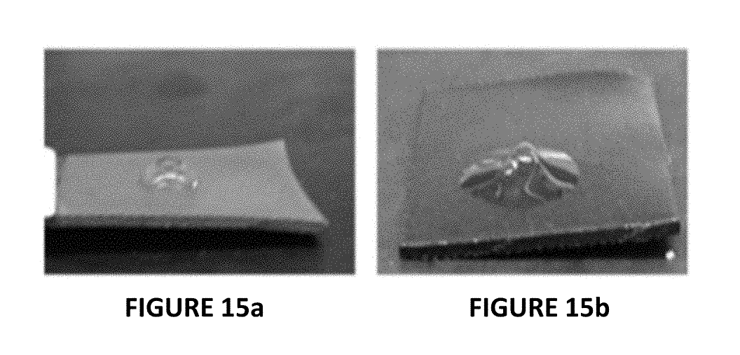

Without wishing to be bound by any particular theory, certain configurations of the coatings disclosed herein (see FIG. 16) can work by trapping media such as gases or liquids between the structures of the surface texture. Other macroscopic objects may remain on top of the surface texture. Some part of the macroscopic object can be in contact with the media and not the surface. As a result, compared to uncoated surfaces, transfer between the macroscopic object and the coated surface is discouraged. Macroscopic objects include, but are not limited to, liquid droplets, a part of a human or animal body, tools and solid objects. As shown in FIG. 16, the surface of the textured coating may have reduced loading by microscale and nanoscale objects, chemicals and molecules than a regular surface. For example, microscale and nanoscale objects include, but are not limited to, particles, microorganisms, viruses, etc. Chemicals and molecules include but are not limited to molten substances and fluids at high temperatures. In certain instances, the coatings can enable protection against undesirable consequences of contact between the surface and the macroscopic, microscale and/or nanoscale objects such as equipment damage, corrosion, transfer of germs, dirt, and smudge, friction and drag. In other instances, liquids may not stick to the coating surface. Liquids for example can be water, sea water, oil, acids, bases, or biological fluids such as blood and urine. In this example, liquid drops bead up on the coating surface, roll off the surface with a slight applied force, and bounce if dropped on the surface from a height. In fact, surface texture can result in such properties of the surface as super-repellency (e.g. superhydrophobicity and superoleophobicity).

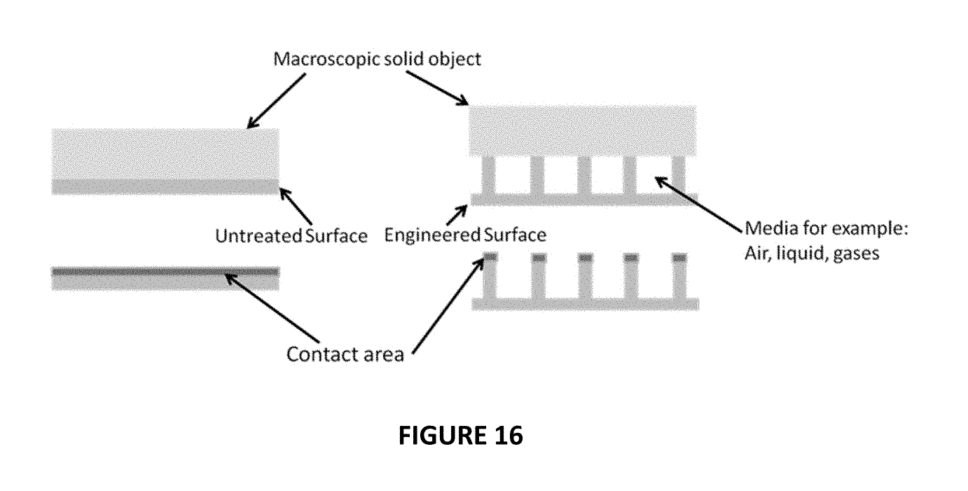

In some instances, if the size of textures is small enough, the micro/nano scale objects may also stay on top of the surface features (FIG. 17). Therefore, some part of the micro/nano scale object can be in contact with the media not the surface. In this scenario, less microscale and nanoscale objects get transferred to the surface. Even if they get transferred to the surface it will be easier to remove them, e.g., less sheer force or cleaning materials is required to remove microscale and nanoscale objects. The micro/nano scale objects can be microbes (such as bacteria, mold, mildew, fungi, etc.), viruses, particles and dirt.

In some examples, microscale and nanoscale objects may get entrapped between the structures of the surface texture but get transferred less to the macroscopic object touching the surface (see FIG. 17). In addition, the entrapment of microorganisms between topographical features may delay colonization of the surface through affecting different activities of microorganisms including but not limited to growth, motility, and cell to cell communication.

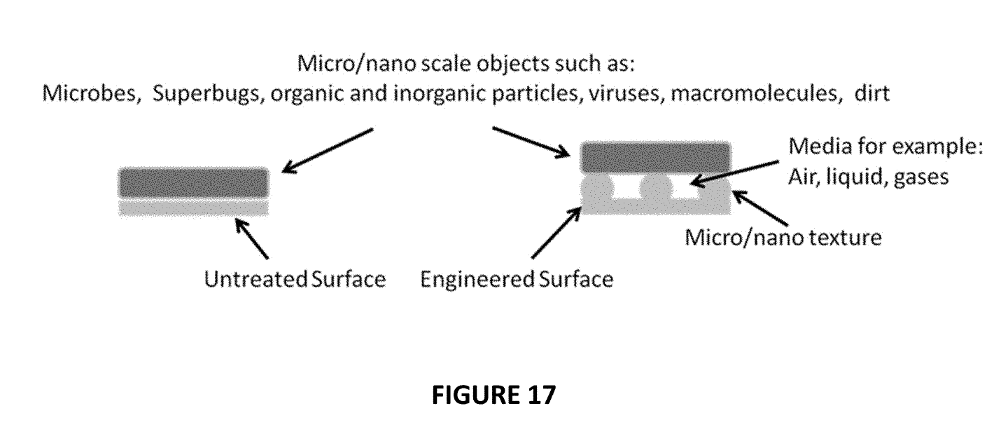

In some instances, the surface may be in contact with fluids including liquids and gases that contain particles, microorganisms, dirt, chemicals, reactive agents, macromolecules, etc. (see FIG. 18). The liquid for example can be water, sea water, oil, acids, bases, or biological fluids such as blood and urine. At these conditions, surface texture can result in reducing the transfer of microscale and nanoscale objects, chemicals or/and reactive agents dissolved in fluid, etc. to the surface. The reason is surface texture can result in such properties of the surface as super-repellency (e.g. superhydrophobicity and superoleophobicity) or superwetting (e.g. superhydrophilicity or superoleophilicity).

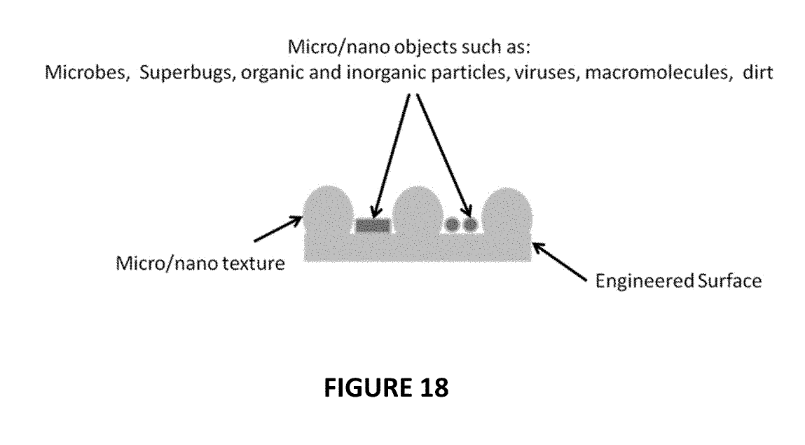

In some examples, the shape of surface features can reduce the transfer to the surface or make the transfer from the surface easier (see FIG. 19). For instance, if the top of surface features is not flat, i.e., it is sharp or curved, objects may make less contact area on engineered surface. In addition, microscopic objects may need to go through more/unusual deformation upon contact with an engineered surface with sharp or curved surface features. The deformation may not be favorable, for example due to the energetic costs associated with it. Therefore, the micro- and nanoscale objects may not attach to the surface or may loosely attach and consequently easily detach from the surface.

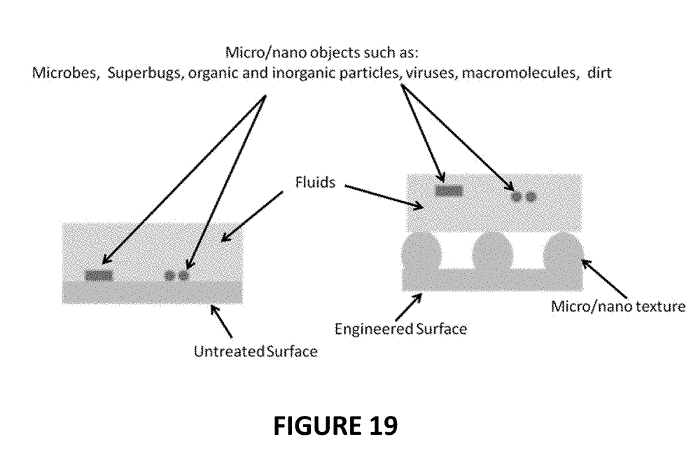

In another example, a layer of fluid for example a vapor can be formed between the structures of the surface texture at high temperatures and discourages adhesion of the macroscopic object to the coated surface (FIG. 20).

In some examples, the coatings disclosed herein can be deposited on the surface of a mold. The mold can be used for making textured surfaces by transferring the negative replica of the coating's texture into the surface of a polymer, ceramic, or glass in a molding process. Examples of the molding process include but not limiting to rotational molding, injection molding, blow molding, compression molding, film insert molding, gas assist molding, structural foam molding, and thermoforming.

In some instances, the coated surface disclosed in the embodiments described herein may be present on an article selected from the group consisting of faucets, door knobs, flush toilets, bathroom fittings, pens, bed-rails, trays, hand-dryers, any appliances, tables, desks, molds, pipes, medical devices and implants, automotive vehicles, airplanes, ambulances, high touch surfaces in hospitals, surfaces in cleanroom, biomedical and food packaging, surfaces in public transit areas, surfaces in swimming pools, surfaces in public bathrooms, electronics glass screens, ovens, grills, ranges, heat-exchangers, condensers, razors, ships, cellphone cases, razor cartridges and handles. The substrate that the coating is applied on can be a metal substrate, wood substrate, plastic substrate, composite substrate, or any combinations thereof.

When introducing elements of the aspects, embodiments, configurations, examples, etc. disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. An article comprising:
a substrate comprising a surface; and
a hydrophobic coating disposed on some portion of the surface, the coating comprising a textured layer comprising at least one metal or metallic compound and comprising a plurality of individual surface features in a micro- or nano-structure size range, wherein the plurality of surface features are positioned in different planes in different heights with respect to a reference zero point in the textured layer, and wherein there is substantially no space between the plurality of surface features of the textured layer.

2. The article of claim 1, wherein each of the plurality of surface features comprises smaller features to provide a hierarchical structure in the textured layer.

3. The article of claim 1, wherein the metal of the textured layer is selected from the group consisting of nickel, copper, zinc, cobalt, chromium, manganese, silver, gold, titanium, cadmium, platinum, other transition metals and combinations thereof.

4. The article of claim 1, wherein the metallic compound is selected from the group consisting of metal oxides, metal carbides, metal nitrides, metal hydroxides, metal carbonitrides, metal oxynitrides, metal borides, metal borocarbides, metal fluorides, other metal compounds, and combination thereof.

5. The article of claim 1, wherein the textured layer comprises a composite of metals or metallic compounds and nanoparticles.

6. The article of claim 5, wherein the nanoparticles are selected from the group consisting of PTFE particles, silica particles, alumina particles, silicon carbide, diatomaceous earth, boron nitride, titanium oxide, platinum oxide, diamond, particles formed from differential etching of spinodally decomposed glass, single wall carbon nanotubes, mix silicon/titanium oxide particles (TiO2/SiO2, titanium inner core/silicon outer surface), ceramic particles, thermo-chromic metal oxide, multi-wall carbon nanotubes, any chemically or physically modified versions of the foregoing particles, and any combinations thereof.

7. The article of claim 1, further comprising one or multiple conformal coating layers disposed on the textured layer.

8. The article of claim 7, wherein the conformal coating layers comprise one or more of Chromium Nitride (CrN), Diamond Like Carbon (DLC), Titanium Nitride (TiN), Titanium Carbo-nitride (TiCN), Aluminum Titanium Nitride (ALTiN), Aluminum Titanium Chromium Nitride (AlTiCrN), Zirconium Nitride (ZrN), Nickel, gold, PlasmaPlus®, Cerablack™, Chromium, Nickel Fluoride (NiF2), any Nickel Composite, any organic or inorganic-organic material and combinations thereof.

9. The article of claim 8, wherein the conformal coating layer comprises the nickel composite and the nickel composite is a composite of nickel with particles selected from the group consisting of PTFE, silica (SiO2), alumina (Al2O3), silicon carbide (SiC), diamond, diatomaceous earth (DE), boron nitride (BN), titanium oxide (TiO2), single wall carbon nanotubes (SWCNTs), multi-wall carbon nanotubes (MWCNTs), kaoline (Al2O3.2SiO2.2H2O), graphite, other nanoparticles, and any combinations thereof.

10. The article of claim 8, wherein the conformal coating layer comprises the organic or inorganic-organic material and the organic or inorganic-organic material is selected from the group consisting of parylene, organofunctional silanes, fluorinated organofunctional silane, fluorinated organofunctional siloxane, organo-functional oligomeric siloxane, organofunctional resins, hybrid inorganic organofunctional resins, low-surface-energy resins, organofunctional polyhedral oligomeric silsesquioxane (POSS), hybrid inorganic organofunctional POSS resins, fluorinated oligomeric poly siloxane, organofunctional oligomeric poly siloxane, hybrid inorganic organofunctional oligomeric poly siloxane, fluorinated organofunctional silicone copolymers, organofunctional silicone polymers, hybrid inorganic organofunctional silicone polymers, organofunctional silicone copolymers, hybrid inorganic organofunctional silicone copolymers, fluorinated polyhedral oligomeric silsesquioxane (FPOSS), non-volatile linear and branched alkanes, alkenes and alkynes; esters of linear and branched alkanes, alkenes and alkynes, perfluorinated organic material, silane coupling agents Dynasylan® SIVO, other similar groups, or any combination thereof, parylene, organofunctional silanes, fluorinated alkylsilane, fluorinated alkylsiloxane, organofunctional resins, hybrid inorganic organofunctional resins, organofunctional polyhedral oligomeric silsesquioxane (POSS), hybrid inorganic organofunctional POSS resins, silicone polymers, fluorinated oligomeric polysiloxane, organofunctional oligomeric poly siloxane, fluorinated organofunctional silicone copolymers, organofunctional silicone polymers, hybrid inorganic organofunctional silicone polymers, organofunctional silicone copolymers, hybrid inorganic organofunctional silicone copolymers, fluorinated polyhedral oligomeric silsesquioxane (FPOSS), Dynasylan® SIVO, other similar groups, or any combination thereof.

11. The article of claim 1, wherein the coating comprises a water contact angle of more than 90 degrees as tested by the ASTM D7490-13 standard.

12. The article of claim 1, wherein the coating has a pencil hardness level of more than 3B as tested by ASTM D3363-05(2011)e2 standard.

13. The article of claim 1, wherein the coating meets at least level three of durability in the pull-off test (tape test) as tested by the ASTM F2452-04-2012 standard.

14. The article of claim 1, further comprising an additional layer disposed on the textured layer, wherein the additional layer comprises a lubricant, a polymer blend, nanoparticles, or any combination thereof.

15. The article of claim 14, wherein the additional layer comprises the nanoparticles and the nanoparticles are either treated with a low surface energy material in advance or a low surface energy material is added to the chemical blend of the additional layer and wherein the nanoparticles comprise silica (SiO2), alumina (Al2O3), silicon carbide (SiC), diamond, diatomaceous earth (DE), boron nitride (BN), titanium oxide (TiO2), single wall carbon nanotubes (SWCNTs), multi-wall carbon nanotubes (MWCNTs), kaoline (Al2O3.2SiO2.2H2O), or any combination thereof.

16. The article of claim 14, wherein the additional layer comprises the nanoparticles and wherein the nanoparticles comprise hydrophobic ceramic-based particles selected from the group consisting of hydrophobic fumed silica particles, hydrophobic diatomaceous earth (DE) particles, hydrophobic pyrogenic silica particles or any combination thereof.

17. The article of claim 14, wherein the additional layer comprises a polymer blend and wherein the polymer blend comprises one or more of organic polymers, thermoplastic polymers, thermosetting polymers, copolymers, terpolymers, a block copolymer, an alternating block copolymer, a random polymer, homopolymer, a random copolymer, a random block copolymer, a graft copolymer, a star block copolymer, a dendrimer, a poly electrolyte, a polyampholyte (a polyelectrolyte having both cationic and anionic repeat groups), and an ionomer.

18. The article of claim 1, wherein the substrate is configured as a pipe and the hydrophobic coating comprises zinc.

19. The article of claim 1, wherein the substrate is configured as a heating device and the hydrophobic coating comprises nickel.

20. The article of claim 1, wherein the substrate is configured as a polymer mold and the hydrophobic coating comprises zinc.

21-52. (canceled)
